(19) United States
(12) Patent Application Publication
(10) Pub. No.: US 2023/0036584 A1
(43) Pub. Date: Feb. 2, 2023

(54) METHOD AND APPARATUS FOR TRANSMITTING MAC PDU ON BASIS OF SIDELINK GRANT IN NR V2X

(71) Applicant: LG ELECTRONICS INC., Seou;l, (KR)

(72) Inventors: Jongyoul LEE, Seoul (KR); Hanbiyul SEO, Seoul (KR); Giwon PARK, Seoul (KR)

(73) Assignee: LG ELECTRONICS INC., Seou;l (KR)

(21) Appl. No.: 17/769,586

(22) PCT Filed: Jul. 8, 2020
(86) PCT No.: PCT/KR2020/008875

§ 371 Date: Apr. 15, 2022

Related U.S. Application Data
(60) Provisional application No. 62/916,145, filed on Oct. 16, 2019.

(30) Foreign Application Priority Data
Dec. 6, 2019 (KR) 10-2019-0162107
Feb. 3, 2020 (KR) 10-2020-0012603

(51) Int. Cl. H04W 72/12; H04L 1/18

(52) U.S. Cl. CPC H04W 72/1263; H04W 72/1278; H04L 1/1812; H04W 80/02

(57) ABSTRACT

Proposed is a method for performing, by a first apparatus, wireless communication. The method may receive, from a base station, information associated with a first sidelink (SL) resource, generate a medium access control protocol data unit (MAC PDU) including a sidelink packet in which hybrid automatic repeat request (HARQ) feedback is enabled on the basis of a logical channel priority (LCP), and reselect a second SL resource for transmitting the MAC PDU.

### BACKGROUND OF THE DISCLOSURE

### Field of the Disclosure

This disclosure relates to a wireless communication system.

### Related Art

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

FIG. 1 is a drawing for describing V2X communication based on NR, compared to V2X communication based on RAT used before NR. The embodiment of FIG. 1 may be combined with various embodiments of the present disclosure.

Regarding V2X communication, a scheme of providing a safety service, based on a V2X message such as Basic Safety Message (BSM), Cooperative Awareness Message (CAM), and Decentralized Environmental Notification Message (DENM) is focused in the discussion on the RAT used before the NR. The V2X message may include position information, dynamic information, attribute information, or the like. For example, a UE may transmit a periodic message type CAM and/or an event triggered message type DENM to another UE.

For example, the CAM may include dynamic state information of the vehicle such as direction and speed, static data of the vehicle such as a size, and basic vehicle information such as an exterior illumination state, route details, or the like. For example, the UE may broadcast the CAM, and latency of the CAM may be less than 100 ms. For example, the UE may generate the DENM and transmit it to another UE in an unexpected situation such as a vehicle breakdown, accident, or the like. For example, all vehicles within a transmission range of the UE may receive the CAM and/or the DENM. In this case, the DENM may have a higher priority than the CAM.

Thereafter, regarding V2X communication, various V2X scenarios are proposed in NR. For example, the various V2X scenarios may include vehicle platooning, advanced driving, extended sensors, remote driving, or the like.

For example, based on the vehicle platooning, vehicles may move together by dynamically forming a group. For example, in order to perform platoon operations based on the vehicle platooning, the vehicles belonging to the group may receive periodic data from a leading vehicle. For example, the vehicles belonging to the group may decrease or increase an interval between the vehicles by using the periodic data.

For example, based on the advanced driving, the vehicle may be semi-automated or fully automated. For example, each vehicle may adjust trajectories or maneuvers, based on data obtained from a local sensor of a proximity vehicle and/or a proximity logical entity. In addition, for example, each vehicle may share driving intention with proximity vehicles.

For example, based on the extended sensors, raw data, processed data, or live video data obtained through the local sensors may be exchanged between a vehicle, a logical entity, a UE of pedestrians, and/or a V2X application server. Therefore, for example, the vehicle may recognize a more improved environment than an environment in which a self-sensor is used for detection.

For example, based on the remote driving, for a person who cannot drive or a remote vehicle in a dangerous environment, a remote driver or a V2X application may operate or control the remote vehicle. For example, if a route is predictable such as public transportation, cloud computing based driving may be used for the operation or control of the remote vehicle. In addition, for example, an access for a cloud-based back-end service platform may be considered for the remote driving.

Meanwhile, a scheme of specifying service requirements for various V2X scenarios such as vehicle platooning, advanced driving, extended sensors, remote driving, or the like is discussed in NR-based V2X communication.

### SUMMARY OF THE DISCLOSURE

### Technical Objects

On the other hand, in NR V2X, when HARQ restriction of a sidelink (SL) grant is applied, a base station may not be able to transmit a grant of an appropriate type to a transmitting UE. More specifically, for example, a base station transmits a first type SL grant to a transmitting UE, while the transmitting UE configures/generates a MAC PDU only with data/packets in which HARQ feedback is deactivated through an LCP procedure. For example, a base station transmits a second type SL grant to a transmitting UE, while the transmitting UE configures/generates a MAC PDU only with data/packets in which HARQ feedback is activated through an LCP procedure. Due to the above-mentioned mismatch, various problems may occur. For example, when a base station transmits a second type SL grant to a transmitting UE, and the transmitting UE transmits a HARQ enable MAC PDU to a receiving UE, the transmitting UE may not be able to perform SL transmission within an appropriate latency budget.

### Technical Solutions

In one embodiment, a method for performing, by a first apparatus, wireless communication is proposed. The method may comprise: receiving information related to a first sidelink (SL) resource, from a base station, generating a medium access control protocol data unit (MAC PDU), including a sidelink packet for which a hybrid automatic repeat request (HARQ) feedback is enabled, based on a logical channel priority (LCP), reselecting a second SL resource for transmitting the MAC PDU.

### Effects of the Disclosure

The user equipment (UE) may efficiently perform SL communication.

### BRIEF DESCRIPTION OF THE DRAWINGS

FIG. 1 is a drawing for describing V2X communication based on NR, compared to V2X communication based on RAT used before NR.

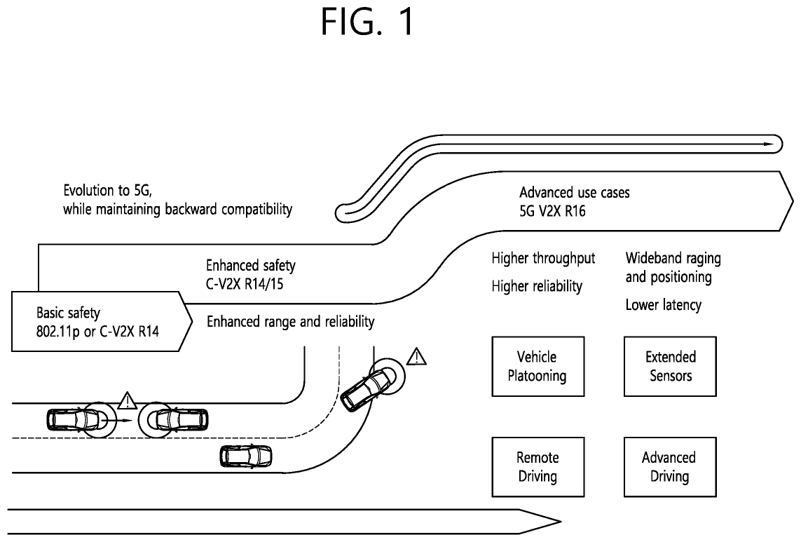

FIG. 2 shows a structure of an NR system, in accordance with an embodiment of the present disclosure.

FIG. 3 shows a functional division between an NG-RAN and a 5GC, in accordance with an embodiment of the present disclosure.

FIG. 4 shows a radio protocol architecture, in accordance with an embodiment of the present disclosure.

FIG. 5 shows a structure of an NR system, in accordance with an embodiment of the present disclosure.

FIG. 6 shows a structure of a slot of an NR frame, in accordance with an embodiment of the present disclosure.

FIG. 7 shows an example of a BWP, in accordance with an embodiment of the present disclosure.

FIG. 8 shows a radio protocol architecture for a SL communication, in accordance with an embodiment of the present disclosure.

FIG. 9 shows a UE performing V2X or SL communication, in accordance with an embodiment of the present disclosure.

FIG. 10 shows a procedure of performing V2X or SL communication by a UE based on a transmission mode, in accordance with an embodiment of the present disclosure.

FIG. 11 shows three cast types, in accordance with an embodiment of the present disclosure.

FIG. 12 shows an example of CG type 1 related to uplink transmission.

FIG. 13 shows an example of CG type 2 related to uplink transmission.

FIG. 14 shows a procedure for a UE to reselect a resource according to an embodiment of the present disclosure.

FIG. 15 shows a procedure for a transmitting UE to reselect a resource for transmitting a MAC PDU based on SR/BSR according to an embodiment of the present disclosure.

FIG. 16 shows a procedure for a transmitting UE to reselect a resource for transmitting a MAC PDU based on sensing according to an embodiment of the present disclosure.

FIG. 17 shows a procedure for reselecting a resource by a transmitting UE according to an embodiment of the present disclosure.

FIG. 18 shows a method for a first apparatus to reselect a resource for transmitting a MAC PDU according to an embodiment of the present disclosure.

FIG. 19 shows a method for a base station to allocate resources to a first apparatus according to an embodiment of the present disclosure.

FIG. 20 shows a communication system 1, in accordance with an embodiment of the present disclosure.

FIG. 21 shows wireless devices, in accordance with an embodiment of the present disclosure.

FIG. 22 shows a signal process circuit for a transmission signal, in accordance with an embodiment of the present disclosure.

FIG. 23 shows a wireless device, in accordance with an embodiment of the present disclosure.

FIG. 24 shows a hand-held device, in accordance with an embodiment of the present disclosure.

FIG. 25 shows a car or an autonomous vehicle, in accordance with an embodiment of the present disclosure.

### DESCRIPTION OF EXEMPLARY EMBODIMENTS

In the present specification, “A or B” may mean “only A”, “only B” or “both A and B.” In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDCCH” may be proposed as an example of the “control information”. In addition, when indicated as “control information (i.e., PDCCH)”, it may also mean that “PDCCH” is proposed as an example of the “control information”.

A technical feature described individually in one figure in the present specification may be individually implemented, or may be simultaneously implemented.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

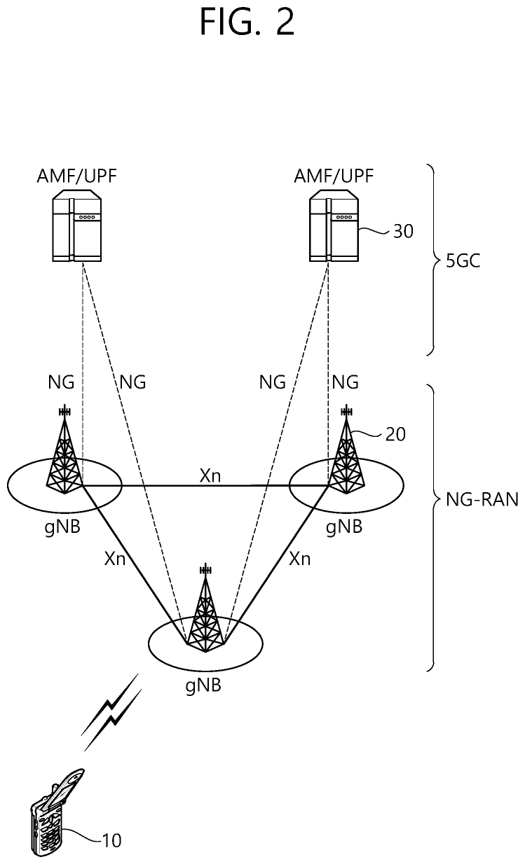

FIG. 2 shows a structure of an NR system, in accordance with an embodiment of the present disclosure. The embodiment of FIG. 2 may be combined with various embodiments of the present disclosure.

Referring to FIG. 2, a next generation-radio access network (NG-RAN) may include a BS 20 providing a UE 10 with a user plane and control plane protocol termination. For example, the BS 20 may include a next generation-Node B (gNB) and/or an evolved-NodeB (eNB). For example, the UE 10 may be fixed or mobile and may be referred to as other terms, such as a mobile station (MS), a user terminal (UT), a subscriber station (SS), a mobile terminal (MT), wireless device, and so on. For example, the BS may be referred to as a fixed station which communicates with the UE 10 and may be referred to as other terms, such as a base transceiver system (BTS), an access point (AP), and so on.

The embodiment of FIG. 2 exemplifies a case where only the gNB is included. The BSs 20 may be connected to one another via Xn interface. The BS 20 may be connected to one another via 5th generation (5G) core network (5GC) and NG interface. More specifically, the BSs 20 may be connected to an access and mobility management function (AMF) 30 via NG-C interface, and may be connected to a user plane function (UPF) 30 via NG-U interface.

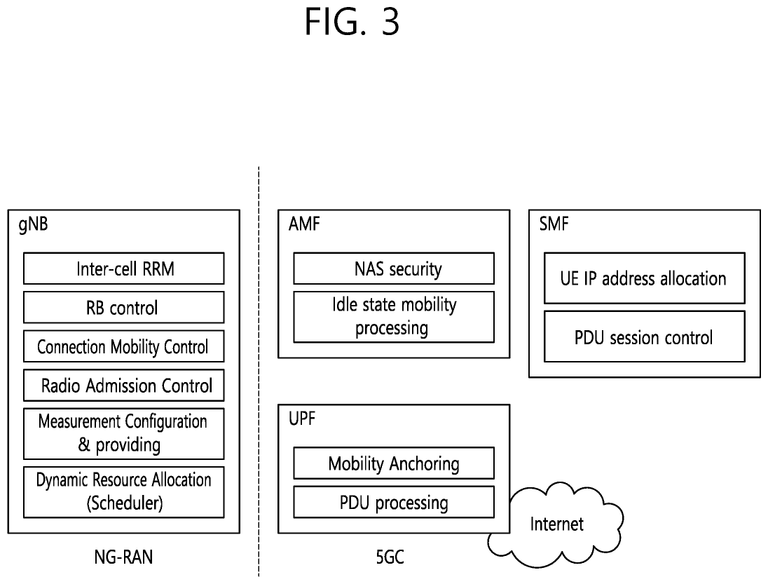

FIG. 3 shows a functional division between an NG-RAN and a 5GC, in accordance with an embodiment of the present disclosure.

Referring to FIG. 3, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

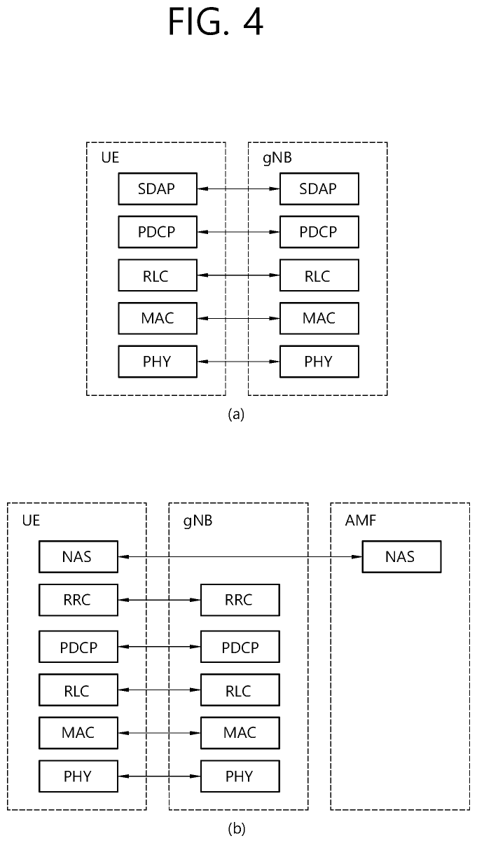

FIG. 4 shows a radio protocol architecture, in accordance with an embodiment of the present disclosure. The embodiment of FIG. 4 may be combined with various embodiments of the present disclosure. Specifically, FIG. 4(a) shows a radio protocol architecture for a user plane, and FIG. 4(b) shows a radio protocol architecture for a control plane. The user plane corresponds to a protocol stack for user data transmission, and the control plane corresponds to a protocol stack for control signal transmission.

Referring to FIG. 4, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., the MAC layer, the RLC layer, and the packet data convergence protocol (PDCP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several sub-carriers in a frequency domain. One sub-frame includes a plurality of OFDM symbols in the time domain. A resource block is a unit of resource allocation, and consists of a plurality of OFDM symbols and a plurality of sub-carriers. Further, each subframe may use specific sub-carriers of specific OFDM symbols (e.g., a first OFDM symbol) of a corresponding subframe for a physical downlink control channel (PDCCH), i.e., an L1/L2 control channel. A transmission time interval (TTI) is a unit time of subframe transmission.

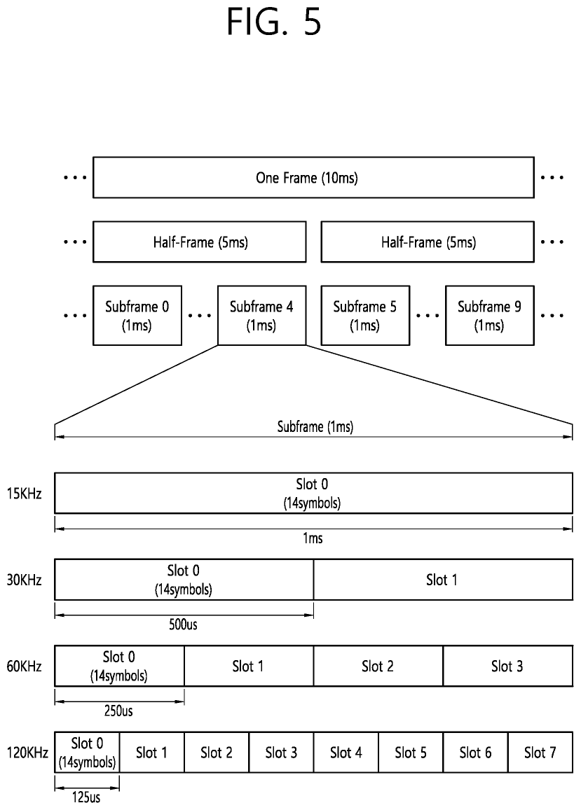

FIG. 5 shows a structure of an NR system, in accordance with an embodiment of the present disclosure. The embodiment of FIG. 5 may be combined with various embodiments of the present disclosure.

Referring to FIG. 5, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined in accordance with subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table 1 shown below represents an example of a number of symbols per slot (N^{slot}_{symb}), a number slots per frame (N^{frame}ₛₗₒₜ), and a number of slots per subframe (N^{subframe,u}ₛₗₒₜ) in accordance with an SCS configuration (u), in a case where a normal CP is used.

TABLE 1

| SCS (15*2^{u}) | N_{symb}^{slot} | Nₛₗₒₜ^{frame, u} | Nₛₗₒₜ^{subframe, u} |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

Table 2 shows an example of a number of symbols per slot, a number of slots per frame, and a number of slots per subframe in accordance with the SCS, in a case where an extended CP is used.

TABLE 2

| SCS (15*2^{u}) | N_{symb}^{slot} | Nₛₗₒₜ^{frame, u} | Nₛₗₒₜ^{subframe, u} |
|---|---|---|---|
| 60 KHz (u = 2) | 12 | 40 | 4 |

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table 3. Among the frequency ranges that are used in an NR system, FR1 may mean a “sub 6 GHz range”, and FR2 may mean an “above 6 GHz range” and may also be referred to as a millimeter wave (mmW).

TABLE 3

| Frequency Range | Corresponding frequency | Subcarrier Spacing |
|---|---|---|
| designation | range | (SCS) |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed (or varied). For example, as shown below in Table 4, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

TABLE 4

| Frequency Range | Corresponding frequency | Subcarrier Spacing |
|---|---|---|
| designation | range | (SCS) |
| FR1 | 410 MHz-7125 MHz | 15, 30, 60 kHz |
| FR2 | 24250 MHz-52600 MHz | 60, 120, 240 kHz |

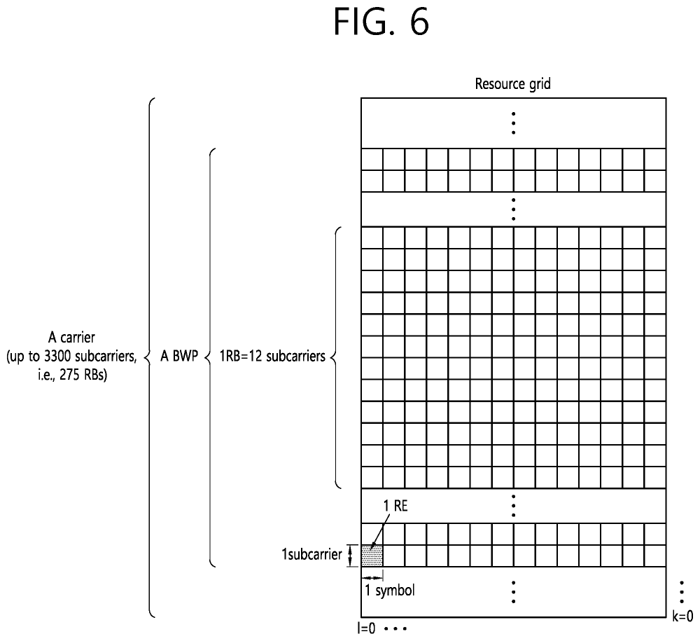

FIG. 6 shows a structure of a slot of an NR frame, in accordance with an embodiment of the present disclosure.

Referring to FIG. 6, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Meanwhile, a radio interface between a UE and another UE or a radio interface between the UE and a network may consist of an L1 layer, an L2 layer, and an L3 layer. In various embodiments of the present disclosure, the L1 layer may imply a physical layer. In addition, for example, the L2 layer may imply at least one of a MAC layer, an RLC layer, a PDCP layer, and an SDAP layer. In addition, for example, the L3 layer may imply an RRC layer.

Hereinafter, a bandwidth part (BWP) and a carrier will be described.

The BWP may be a set of consecutive physical resource blocks (PRBs) in a given numerology. The PRB may be selected from consecutive sub-sets of common resource blocks (CRBs) for the given numerology on a given carrier.

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a position change of the bandwidth, or a change in subcarrier spacing of the bandwidth.

For example, the bandwidth may be decreased during a period in which activity is low to save power. For example, the position of the bandwidth may move in a frequency domain. For example, the position of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be called a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, PDSCH, or CSI-RS (excluding RRM) outside the active DL BWP. For example, the UE may not trigger a channel state information (CSI) report for the inactive DL BWP. For example, the UE may not transmit PUCCH or PUSCH outside an active UL BWP. For example, in a downlink case, the initial BWP may be given as a consecutive RB set for an RMSI CORESET (configured by PBCH). For example, in an uplink case, the initial BWP may be given by SIB for a random access procedure. For example, the default BWP may be configured by a higher layer. For example, an initial value of the default BWP may be an initial DL BWP. For energy saving, if the UE fails to detect DCI during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

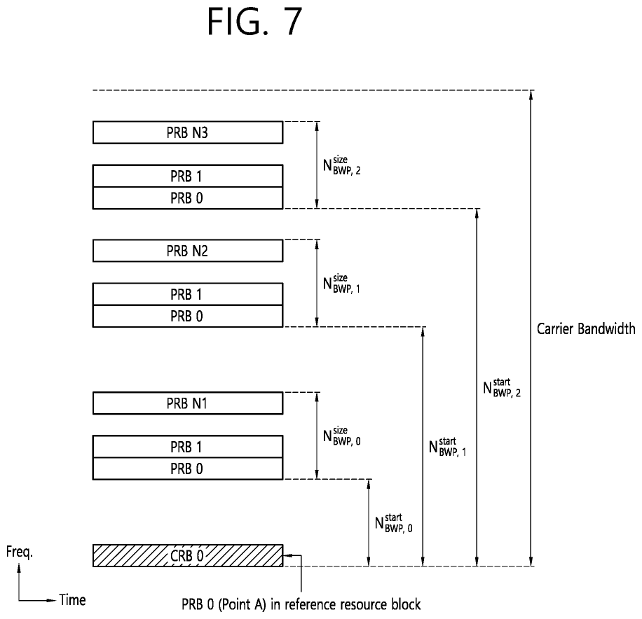

FIG. 7 shows an example of a BWP, in accordance with an embodiment of the present disclosure. The embodiment of FIG. 7 may be combined with various embodiments of the present disclosure. It is assumed in the embodiment of FIG. 7 that the number of BWPs is 3.

Referring to FIG. 7, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{BWP} from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described.

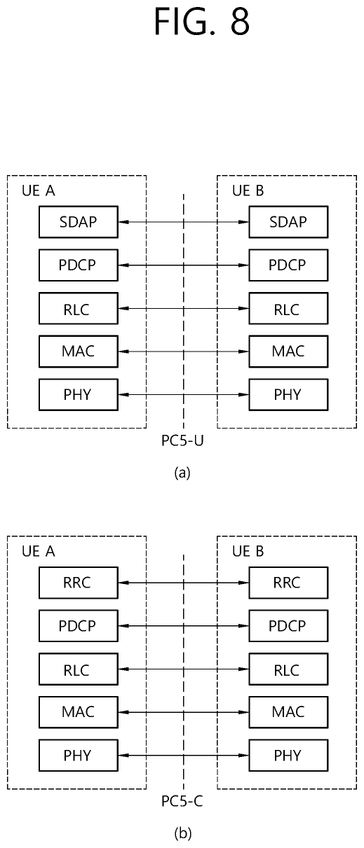

FIG. 8 shows a radio protocol architecture for a SL communication, in accordance with an embodiment of the present disclosure. The embodiment of FIG. 8 may be combined with various embodiments of the present disclosure. More specifically, FIG. 8(a) shows a user plane protocol stack, and FIG. 8(b) shows a control plane protocol stack.

Hereinafter, a sidelink synchronization signal (SLSS) and synchronization information will be described.

The SLSS may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit CRC.

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

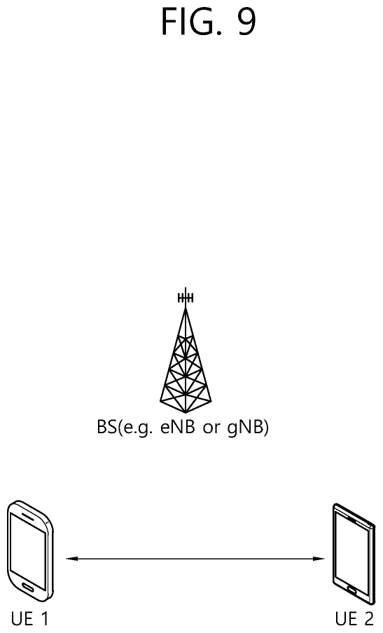

FIG. 9 shows a UE performing V2X or SL communication, in accordance with an embodiment of the present disclosure. The embodiment of FIG. 9 may be combined with various embodiments of the present disclosure.

Referring to FIG. 9, in V2X or SL communication, the term ‘UE’ may generally imply a UE of a user. However, if a network equipment such as a BS transmits/receives a signal according to a communication scheme between UEs, the BS may also be regarded as a sort of the UE. For example, a UE 1 may be a first apparatus 100, and a UE 2 may be a second apparatus 200.

For example, the UE 1 may select a resource unit corresponding to a specific resource in a resource pool which implies a set of series of resources. In addition, the UE 1 may transmit an SL signal by using the resource unit. For example, a resource pool in which the UE 1 is capable of transmitting a signal may be configured to the UE 2 which is a receiving UE, and the signal of the UE 1 may be detected in the resource pool.

Herein, if the UE 1 is within a connectivity range of the BS, the BS may inform the UE 1 of the resource pool. Otherwise, if the UE 1 is out of the connectivity range of the BS, another UE may inform the UE 1 of the resource pool, or the UE 1 may use a pre-configured resource pool.

In general, the resource pool may be configured in unit of a plurality of resources, and each UE may select a unit of one or a plurality of resources to use it in SL signal transmission thereof.

Hereinafter, resource allocation in SL will be described.

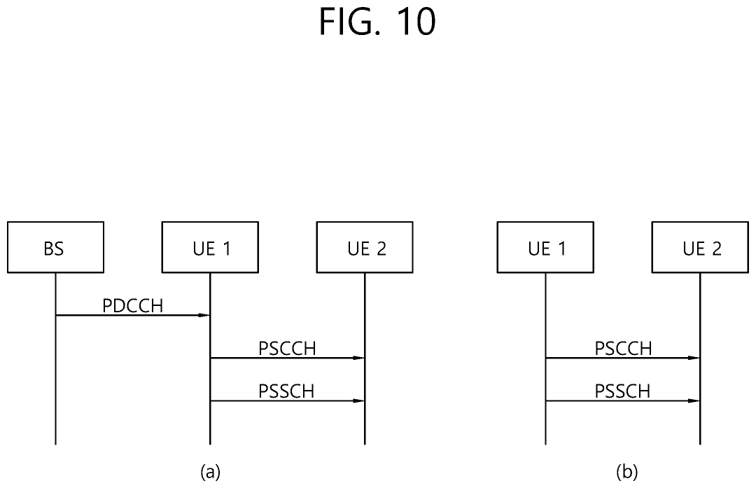

FIG. 10 shows a procedure of performing V2X or SL communication by a UE based on a transmission mode, in accordance with an embodiment of the present disclosure. The embodiment of FIG. 10 may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, FIG. 10(a) shows a UE operation related to an LTE transmission mode 1 or an LTE transmission mode 3. Alternatively, for example, FIG. 10(a) shows a UE operation related to an NR resource allocation mode 1. For example, the LTE transmission mode 1 may be applied to general SL communication, and the LTE transmission mode 3 may be applied to V2X communication.

For example, FIG. 10(b) shows a UE operation related to an LTE transmission mode 2 or an LTE transmission mode 4. Alternatively, for example, FIG. 10(b) shows a UE operation related to an NR resource allocation mode 2.

Referring to FIG. 10(a), in the LTE transmission mode 1, the LTE transmission mode 3, or the NR resource allocation mode 1, a BS may schedule an SL resource to be used by the UE for SL transmission. For example, the BS may perform resource scheduling to a UE 1 through a PDCCH (more specifically, downlink control information (DCI)), and the UE 1 may perform V2X or SL communication with respect to a UE 2 according to the resource scheduling. For example, the UE 1 may transmit a sidelink control information (SCI) to the UE 2 through a physical sidelink control channel (PSCCH), and thereafter transmit data based on the SCI to the UE 2 through a physical sidelink shared channel (PSSCH).

Referring to FIG. 10(b), in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannels. In addition, the UE 1 which has autonomously selected the resource within the resource pool may transmit the SCI to the UE 2 through a PSCCH, and thereafter may transmit data based on the SCI to the UE 2 through a PSSCH.

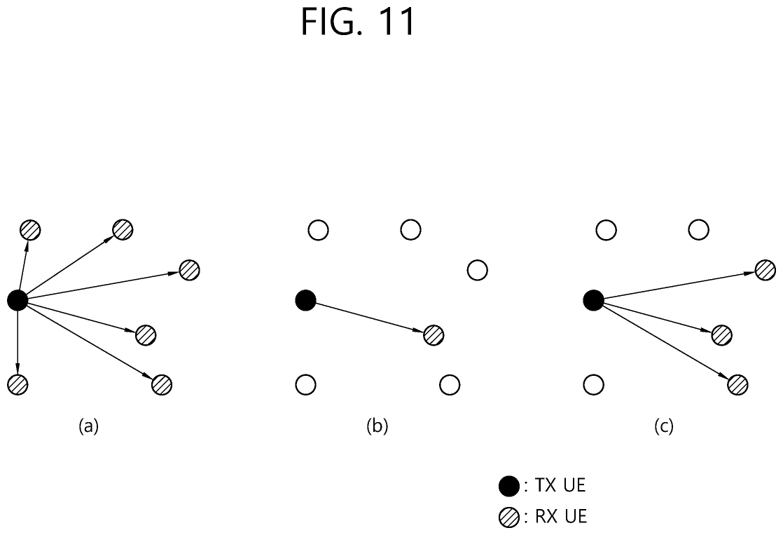

FIG. 11 shows three cast types, in accordance with an embodiment of the present disclosure. The embodiment of FIG. 11 may be combined with various embodiments of the present disclosure. Specifically, FIG. 11(a) shows broadcast-type SL communication, FIG. 11(b) shows unicast type-SL communication, and FIG. 11(c) shows groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

Hereinafter, a hybrid automatic repeat request (HARQ) procedure will be described.

An error compensation scheme is used to secure communication reliability. Examples of the error compensation scheme may include a forward error correction (FEC) scheme and an automatic repeat request (ARQ) scheme. In the FEC scheme, errors in a receiving end are corrected by attaching an extra error correction code to information bits. The FEC scheme has an advantage in that time delay is small and no information is additionally exchanged between a transmitting end and the receiving end but also has a disadvantage in that system efficiency deteriorates in a good channel environment. The ARQ scheme has an advantage in that transmission reliability can be increased but also has a disadvantage in that a time delay occurs and system efficiency deteriorates in a poor channel environment.

A hybrid automatic repeat request (HARQ) scheme is a combination of the FEC scheme and the ARQ scheme. In the HARQ scheme, it is determined whether an unrecoverable error is included in data received by a physical layer, and retransmission is requested upon detecting the error, thereby improving performance.

In case of SL unicast and groupcast, HARQ feedback and HARQ combining in the physical layer may be supported. For example, when a receiving UE operates in a resource allocation mode 1 or 2, the receiving UE may receive the PSSCH from a transmitting UE, and the receiving UE may transmit HARQ feedback for the PSSCH to the transmitting UE by using a sidelink feedback control information (SFCI) format through a physical sidelink feedback channel (PSFCH).

For example, the SL HARQ feedback may be enabled for unicast. In this case, in a non-code block group (non-CBG) operation, if the receiving UE decodes a PSCCH of which a target is the receiving UE and if the receiving UE successfully decodes a transport block related to the PSCCH, the receiving UE may generate HARQ-ACK. In addition, the receiving UE may transmit the HARQ-ACK to the transmitting UE. Otherwise, if the receiving UE cannot successfully decode the transport block after decoding the PSCCH of which the target is the receiving UE, the receiving UE may generate the HARQ-NACK. In addition, the receiving UE may transmit HARQ-NACK to the transmitting UE.

When sidelink HARQ feedback is enabled for groupcast, a UE may determine whether to send HARQ feedback based on the TX-RX distance and/or RSRP. For non-CBG operation, two options may be supported.

(1) Option 1: After a receiving UE decodes an associated PSCCH, if the receiving UE fails to decode the corresponding transport block, the receiving UE may transmit HARQ-NACK on the PSFCH. Otherwise, the receiving UE may not transmit a signal on a PSFCH.

(2) Option 2: When a receiving UE successfully decodes the corresponding transport block, the receiving UE may transmit HARQ-ACK on a PSFCH. After a receiving UE decodes an associated PSCCH targeting the receiving UE, if the receiving UE does not successfully decode the corresponding transport block, the receiving UE may transmit HARQ-NACK on a PSFCH.

In the case of mode 1 resource allocation, the time between HARQ feedback transmission on a PSFCH and a PSSCH may be (pre-)configured. In the case of unicast and groupcast, if retransmission is required on sidelink, this may be indicated to a base station by a UE within coverage using a PUCCH. A transmitting UE may transmit an indication to a serving base station of the transmitting UE in the form of a Scheduling Request (SR)/Buffer Status Report (BSR) rather than a HARQ ACK/NACK format. In addition, even if a base station does not receive the indication, a base station can schedule a sidelink retransmission resource to a UE.

In the case of mode 2 resource allocation, the time between HARQ feedback transmission on a PSFCH and a PSSCH may be (pre-)configured.

On the other hand, in NR V2X, when a UE performs unicast communication or groupcast communication with another UE, in order to increase reliability of information transmitted to another UE, the UE may transmit a HARQ-ACK/NACK signal for the information as a feedback signal.

Meanwhile, in NR, a method of scheduling a resource may include a method of scheduling a resource based on a dynamic grant (hereinafter, DG) and a method of scheduling a resource without a DG. In a DG-based resource scheduling, for every transmission interval (e.g., a slot), a base station or a scheduler may instruct a transmission or a reception by transmitting a control signaling to a UE, and may indicate which resource is used to receive data, at the same time. Such a dynamic scheduling method may have an advantage of being flexible by instructing related control signaling in accordance with rapid variability according to traffic characteristics. On the other hand, a base station or a scheduler may have an overhead of performing control signaling every time. Accordingly, in NR, a supported scheduling scheme without DG can also be supported. A scheduling scheme without DG may be similar to a downlink scheduling scheme and an uplink scheduling scheme. In NR, a scheduling scheme without DG may be referred to as a configured grant (hereinafter, CG) transmission. For example, CG may include CG type 1 and CG type 2.

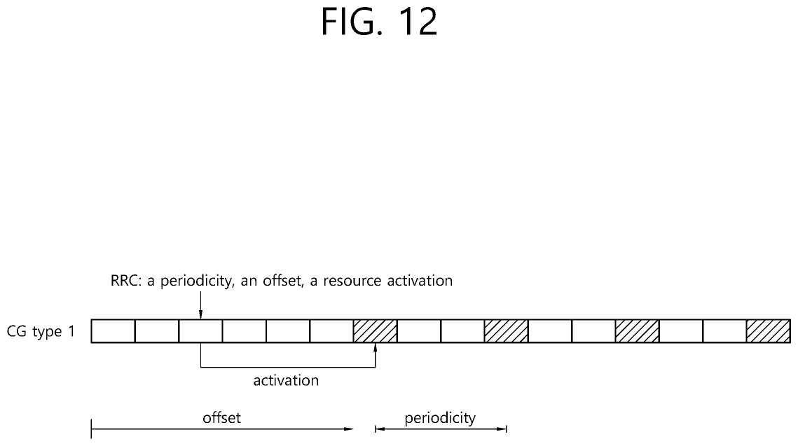

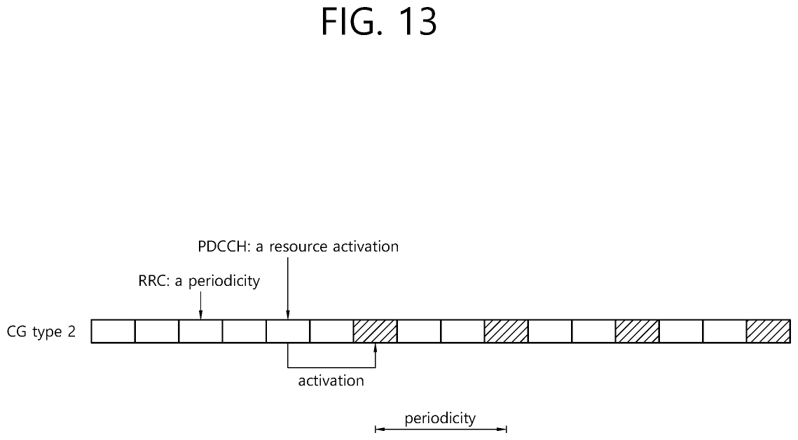

FIG. 12 shows an example of CG type 1 related to uplink transmission. The embodiment of FIG. 12 may be combined with various embodiments of the present disclosure. FIG. 13 shows an example of CG type 2 related to uplink transmission. The embodiment of FIG. 13 may be combined with various embodiments of the present disclosure.

Referring to FIG. 12, based on an uplink scheduling method, in CG type 1, both an uplink grant and an activation of a grant may be scheduled through RRC signaling. For example, in a case of CG type 1, an uplink grant and an activation may be simultaneously transmitted as an RRC configuration, and they may occupy a resource corresponding to a periodicity or a configured transmission periodicity. For example, in CG type 1, an uplink grant and an activation may be simultaneously transmitted to a UE through RRC configuration. A UE may occupy a resource corresponding to a configured transmission period or a period.

Referring to FIG. 13, in CG type 2, a transmission period may be signaled by RRC, and a transmission activation/deactivation may be scheduled by L1/L2 control signaling. For example, in CG type 2, a transmission periodicity or a period may be pre-configured through RRC signaling, by allocating resource activation through L1 signaling (e.g., through PDCCH), a resource corresponding to a pre-configured transmission period may be occupied. For example, in CG type 1, a transmission period or a period may be pre-configured for a UE through RRC signaling. For example, resource activation may be allocated to a UE through L1 signaling. A UE may occupy a resource corresponding to a pre-configured transmission period or a period.

Similarly, NR V2X may support the above-described uplink transmission without a dynamic grant method and a CG type 1 method and a CG type 2 method for sidelink. In addition, in sidelink, a base station may configure or activate all SL semi-persistent scheduling (SPS) resources through an RRC message. In addition, in sidelink, a base station may configure a transmission period for a UE through RRC, a base station may perform an activation/deactivation for a UE through L1 (e.g., PDCCH) signaling.

In addition, a base station may perform resource scheduling for a UE based on DG. In a dynamic scheduling method, a base station may immediately perform resource grant based on a scheduling request (SR)/buffer state report (BSR) transmitted from a UE to the base station.

Meanwhile, in NR sidelink, HARQ operation between sidelink UEs may be supported. According to a HARQ operation, resource scheduling and packet multiplexing may be affected. Here, for example, packet multiplexing may include multiplexing only packets in which HARQ feedback is enabled or disabled when constructing a MAC PDU, or Multiplexing HARQ feedback-enabled packets and HARQ feedback-disabled packets together. In this disclosure, when a UE uses a grant allocated by a base station or performs packet multiplexing, an operation of limiting only packets in which HARQ feedback is enabled or packets in which HARQ feedback is disabled is proposed. Or, when a UE uses a grant allocated by a base station or performs packet multiplexing, a method of indicating to a UE in which HARQ operation a resource grant is used, and performing, by a UE, resource multiplexing regardless of the HARQ operation by a UE implementation is proposed.

According to an embodiment of the present disclosure, when a base station schedules a mode 1 resource grant to a UE, the base station may perform grant allocation by instructing HARQ enable or HARQ disable together through the resource grant.

For example, whether to enable/disable HARQ may be configured based on a sidelink radio bearer (SLRB) level. That is, whether or not HARQ is supported can be configured by a base station for each SLRB according to specific conditions (e.g., QoS, CBR reported from the UE, etc.). For example, when a base station transmits a resource grant to a UE, the base station may indicate by marking SLRB or LCH index mapped to the resource grant. For this, for example, a UE and a base station can both know whether HARQ is enabled/disabled, by which SLRB (or LCH) is to enable HARQ or to disable HARQ is pre-configured between a UE and a base station. Through this, a UE can know whether a resource grant enables or disables HARQ feedback through an SLRB or LCH marked on the resource grant received from a base station. In addition, when constructing a MAC PDU to be transmitted through the corresponding resource grant, a UE may configure by multiplexing only packets having the same attribute according to a HARQ attribute of a packet (i.e., whether the packet requires HARQ or not).

Or, for example, even if a base station does not explicitly mark an SLRB or LCH, by defining an index mapped to the SLRB or LCH in advance, the base station may mark an index on a resource grant and transmit it. For example, an index may be mapped to an SLRB or LCH managed by a base station based on pre-configuration. That is, for example, an index may define whether to enable or disable HARQ. Accordingly, a UE can know whether to enable/disable HARQ through the resource grant as described above, through an index marked on the resource grant allocated from a base station. Alternatively, a UE may multiplex a MAC PDU through the resource grant.

For example, a UE may be assigned a CG from a base station. In this case, when a UE receives a configuration for a CG resource through RRC signaling from a base station, whether or not HARQ is enabled may be included in the configuration of the CG. Or, for example, a CG configuration may include a CG index. For example, by mapping a CG index to whether or not HARQ is enabled in advance, HARQ enable/disable of a CG may be defined or determined according to which CG index is allocated.

According to an embodiment of the present disclosure, when a base station schedules a mode 1 resource grant to a UE, a resource grant that is not limited to a specific HARQ operation (i.e., HARQ enable or HARQ disable) may be allocated or an indication that a HARQ operation is not limited to an allocated resource grant may be configured together. For example, the indication may mean that when a UE uses a resource grant or configures a MAC PDU to be transmitted through a resource grant, the UE may transmit any of MAC PDUs composed of only HARQ-enabled or only HARQ-disabled packets through the resource grant. Also, for example, when a UE configures a MAC PDU, the UE may multiplex a HARQ feedback-enabled packet and a HARQ feedback-disabled packet together and transmit it through a resource grant. That is, a UE can alleviate the half duplex problem by multiplexing a packet in which HARQ feedback is enabled and a packet in which HARQ feedback is disabled in a MAC PDU configuration without restrictions on HARQ operation. In particular, when a transmitting UE and a receiving UE perform a service requiring high reliability, it may be important to alleviate the half duplex problem. In this case, if a HARQ-enabled resource grant and a HARQ-disabled resource grant are separately managed, the transmission probability is doubled, so that the loss probability due to half duplex is also doubled, there is a need to alleviate the half duplex problem by using a resource grant that is not limited in HARQ operation.

For example, in allocating a mode 1 resource grant to a UE, a base station may define or pre-configured that the mode 1 resource grant is not limited to a HARQ operation. For example, by being statically defined or configured in all sidelink mode 1 resource grants in advance, all mode 1 resource grants may be allocated to a UE without limitation in HARQ operation. Or, for example, as described above, a base station may mark a specific indication on a resource grant and transmit it to a UE in order to notify whether a HARQ operation of a mode 1 resource grant is performed. For example, when a base station transmits a resource grant, a specific SLRB or a specific LCH may define or configure that there is no restriction on HARQ operation. For example, a base station may mark a specific SLRB or a specific LCH on a resource grant, or mark an index mapped to an SLRB or LCH on a resource grant, and allocate the resource grant to a UE. For example, a UE can know that there is no limit to a HARQ operation through a received resource grant, and when constructing a MAC PDU to be transmitted through the resource grant, the UE may multiplex both a HARQ-enabled packet and a HARQ-disabled packet.

For example, in the case of configuring a CG resource, as described above, when a UE receives a configuration related to a CG resource through RRC signaling from a base station, the CG configuration may include an indication that there is no limit to a HARQ operation. Or, for example, HARQ enable, HARQ disable, or no limitation on HARQ may be pre-configured for each CG index included in a CG configuration. Based on a CG index of a resource grant allocated by a base station, a UE may know that a HARQ corresponds to an unrestricted resource grant. In addition, when a UE receives multiple CGs from a base station, the UE which received a CG configured to have no HARQ restrictions, may configure a MAC PDU so that there is no restriction on HARQ, and may select and transmit a specific CG according to a QoS characteristics of the MAC PDU.

The present disclosure may be applied to mode 1 resource scheduling for allocating DG and CG, and may also be applied when a base station allocates an initial resource grant or a retransmission resource grant. Also, for example, a base station may allocate a resource grant for disabling HARQ feedback in consideration of a situation such as a latency budget of a UE even in a state in which retransmission resources are allocated.

In this disclosure, an explicit indication may be configured, in addition, it may be defined or configured to be interpreted by a UE as implicitly enabling HARQ without explicit indication, disabling HARQ, or not limiting HARQ. For example, a base station may allocate a PUCCH resource (e.g., a base station may allocate a PUCCH resource for sidelink HARQ uplink report) when transmitting a resource grant to a UE. For example, when there is a PUCCH resource associated with a sidelink grant, a UE may determine that a sidelink grant is HARQ-enabled. When only a sidelink grant is allocated without a PUCCH resource, a UE may determine that the sidelink grant is HARQ disabled. Accordingly, the UE may configure a MAC PDU only with packets allowing a HARQ operation or only with packets that do not allow a HARQ operation, depending on whether a sidelink grant is received along with a PUCCH. That is, for example, a UE may determine whether to multiplex a HARQ-enabled packet and a HARQ-disabled packet together in a MAC PDU configuration according to whether PUCCH resources are allocated. Alternatively, only a sidelink grant to which a PUCCH resource is allocated may be a resource allowing HARQ. For example, a sidelink grant to which PUCCH resources are not allocated together may be defined or configured so that a UE configures and transmits a MAC PDU without limiting HARQ.

In the present disclosure, when a base station transmits a grant to a UE, a base station may allocate a grant configured to one of three states to the UE. For example, the three states may include a HARQ enabled grant for option 1, a HARQ disabled grant for option 2, and a non-HARQ limiting grant for option 3. Accordingly, a UE may configure a MAC PDU according to which grant a base station has transmitted. For example, in a case of option 1, a UE may configure a MAC PDU only for packets requiring HARQ operation. For example, in a case of option 2, a UE may configure a MAC PDU only with packets that do not require HARQ operation. For example, in a case of option 3, a UE multiplexes packets regardless of a HARQ operation by the UE implementation or when the importance of packets requesting HARQ feedback is high (e.g., importance is determined based on QoS), the UE may configure a MAC PDU only with packets that request HARQ feedback preferentially.

The various examples described above may be rules corresponding only to an SL grant for an initial resource in a sidelink mode 1 operation. For example, according to various embodiments of the present disclosure described above, a base station may mark an SL grant with an indicator whether a resource for a HARQ enable operation or a resource for a HARQ disable operation and transmit it to a UE, or a UE may determine whether a resource is for a HARQ enable operation or a resource for a HARQ disable operation implicitly based on whether there is an associated PUCCH resource. In this case, the above-described restriction on an SL grant may be a restriction corresponding only to an initial resource. For example, when a transmitting UE receives a mode 1 dynamic SL grant (e.g., DCI) from a base station, and there is a PUCCH resource associated with a mode 1 dynamic SL grant, the transmitting UE may configure a HARQ enable MAC PDU with a corresponding grant in an initial transmission and transmit it to a receiving UE. If a transmitting UE receives NACK feedback from a receiving UE even though the transmitting UE has used all resources allocated through an initial grant, the transmitting UE may report NACK feedback to a base station in order to be allocated another retransmission resource. In this case, a base station receiving a NACK feedback may transmit an SL grant related to a retransmission resource to a transmitting UE, and there may be no PUCCH resource related to an SL grant related to the retransmission resource. The reason why a base station does not allocate a PUCCH resource through an SL grant related to a retransmission resource as in the above-described embodiment may be because it is expected (or known) that a UE satisfies the maximum number of retransmissions to be transmitted with the SL grant related to the retransmission resource, or may be in order not to waste PUCCH resources because a base station exceeds latency budget even if the base station allocates another additional retransmission resource thereafter. However, at this time, if HARQ restriction is applied to an SL grant related to a retransmission resource, when there is no PUCCH resource related to the SL grant related to the retransmission resource, a transmitting UE may configure only a HARQ disable MAC PDU and transmit it to a receiving UE. However, this operation is an undesirable operation in which retransmission cannot be performed. Therefore, a UE receiving an SL grant may apply the restriction of the SL grant only in an operation of configuring an initial MAC PDU (i.e., logical channel prioritization (LCP) operation), and may transmit a retransmission TB related to an initial transmission TB based on the SL grant related to the retransmission resource even if there is no PUCCH resource in the SL grant.

For example, an LCP operation may be defined as shown in Tables 5 to 9.

TABLE 5

| | |
|---|---|
| 5.4.3.1 | Logical Channel Prioritization |
| 5.4.3.1.1 | General |

The Logical Channel Prioritization (LCP) procedure is applied
whenever a new transmission is performed.
RRC controls the scheduling of uplink data by signalling for each
logical channel per MAC entity:

| | |
|---|---|
| - | priority where an increasing priority value indicates a |
| | lower priority level; |
| - | prioritisedBitRate which sets the Prioritized Bit Rate |
| | (PBR); |
| - | bucketSizeDuration which sets the Bucket Size Duration |
| | (BSD). |

RRC additionally controls the LCP procedure by configuring mapping
restrictions for each logical channel:

| | |
|---|---|
| - | allowedSCS-List which sets the allowed Subcarrier |
| | Spacing(s) for transmission; |
| - | maxPUSCH-Duration which sets the maximum PUSCH |
| | duration allowed for transmission; |
| - | configuredGrantType1Allowed which sets whether a |
| | configured grant Type 1 can be used for transmission; |
| - | allowedServingCells which sets the allowed cell(s) for |
| | transmission. |

The following UE variable is used for the Logical channel prioritization
procedure:

| | |
|---|---|
| - | Bj which is maintained for each logical channel j. |

The MAC entity shall initialize Bj of the logical channel to zero when the
logical channel is established.
For each logical channel j, the MAC entity shall:

| | |
|---|---|
| 1> | increment Bj by the product PBR × T before every instance |
| | of the LCP procedure, where T is the time elapsed since Bj |
| | was last incremented; |
| 1> | if the value of Bj is greater than the bucket size (i.e. |
| | PBR × BSD): |
| | 2> set Bj to the bucket size. |
| NOTE: | The exact moment(s) when the UE updates Bj between |
| | LCP procedures is up to UE implementation, as long |
| | as Bj is up to date at the time when a grant is processed |
| | by LCP. |

Referring to Table 5, an LCP procedure may be applied whenever a new transmission is performed.

TABLE 6

| | |
|---|---|
| 5.4.3.1.2 | Selection of logical channels |

```
The MAC entity shall, when a new transmission is performed:
  1> select the logical channels for each UL grant that satisfy
  all the following conditions:
```

| | |
|---|---|
| 2> | the set of allowed Subcarrier Spacing index values in |
| | allowedSCS-List, if configured, includes the Subcarrier |
| | Spacing index associated to the UL grant; and |
| 2> | maxPUSCH-Duration, if configured, is larger than or |
| | equal to the PUSCH transmission duration associated |
| | to the UL grant; and |
| 2> | configuredGrantType1Allowed, if configured, is set to |
| | true in case the UL grant is a Configured Grant Type 1; and |
| 2> | allowedServingCells, if configured, includes the Cell |
| | information associated to the UL grant. Does not apply |
| | to logical channels associated with a DRB configured |
| | with PDCP duplication within the same MAC entity (i.e. |
| | CA duplication) for which PDCP duplication is deactivated. |
| NOTE: | The Subcarrier Spacing index, PUSCH transmission |
| | duration and Cell information are included in Uplink |
| | transmission information received from lower layers |
| | for the corresponding scheduled uplink transmission. |

Referring to Table 6, in relation to a selection of logical channels, a MAC entity may select logical channels for each uplink grant satisfying all of the conditions shown in Table 6 when new transmission is performed.

TABLE 7

| | |
|---|---|
| 5.4.3.1.3 | Allocation of resources |

The MAC entity shall, when a new transmission is performed:
1> allocate resources to the logical channels as follows:

| | |
|---|---|
| 2> | logical channels selected in clause 5.4.3.1.2 for the UL |
| | grant with Bj > 0 are allocated resources in a decreasing |
| | priority order. If the PBR of a logical channel is set to |
| | infinity, the MAC entity shall allocate resources for all |
| | the data that is available for transmission on the logical |
| | channel before meeting the PBR of the lower priority |
| | logical channel(s); |
| 2> | decrement Bj by the total size of MAC SDUs served to |
| | logical channel j above; |
| 2> | if any resources remain, all the logical channels selected |
| | in clause 5.4.3.1.2 are served in a strict decreasing |
| | priority order (regardless of the value of Bj) until |
| | either the data for that logical channel or the UL grant |
| | is exhausted, whichever comes first. Logical channels |
| | configured with equal priority should be served equally. |
| NOTE: | The value of Bj can be negative. |

TABLE 8
If the MAC entity is requested to simultaneously transmit multiple
MAC PDUs, or if the MAC entity receives the multiple UL grants
within one or more coinciding PDCCH occasions (i.e. on different
Serving Cells), it is up to UE implementation in which order the
grants are processed.
The UE shall also follow the rules below during the scheduling
procedures above:

| | |
|---|---|
| - | the UE should not segment an RLC SDU (or partially |
| | transmitted SDU or retransmitted RLC PDU) if the whole |
| | SDU (or partially transmitted SDU or retransmitted RLC |
| | PDU) fits into the remaining resources of the associated |
| | MAC entity; |
| - | if the UE segments on RLC SDU from the logical channel, it |
| | shall maximize the size of the segment to fill the grant |
| | of the associated MAC entity as much as possible; |
| - | the UE should maximise the transmission of data; |
| - | if the MAC entity is given a UL grant size that is equal |

to or larger than 8 bytes while having data available and allowed
(according to clause 5.4.3.1) for transmission, the MAC entity
shall not transmit only padding BSR and/or padding.

Referring to Tables 7 and 8, in relation to resource allocation, a MAC entity may allocate resources for logical channels as shown in Tables 7 and 8 when new transmission is performed.

TABLE 9
The MAC entity shall not generate a MAC PDU for the HARQ
entity if the following conditions are satisfied:

| | |
|---|---|
| - | the MAC entity is configured with skipUplinkTxDynamic |
| | with value true and the grant indicated to the HARQ entity |
| | was addressed to a C-RNTI, or the grant indicated to the |
| | HARQ entity is a configured uplink grant; and |
| - | there is no aperiodic CSI requested for the PUSCH |
| | transmission as specified in TS 38.212 [9]; and |
| - | the MAC PDU includes zero MAC SDUs; and |
| - | the MAC PDU includes only the periodic BSR and there |
| | is no data available for any LCG, or the MAC PDU |
| | includes only the padding BSR. |

Logical channels shall be prioritised in accordance with the following
order (highest priority listed first):

| | |
|---|---|
| - | C-RNTI MAC CE or data from UL-CCCH; |
| - | Configured Grant Confirmation MAC CE; |
| - | MAC CE for BSR, with exception of BSR included |
| | for padding; |
| - | Single Entry PHR MAC CE, or Multiple Entry PHR |
| | MAC CE; |
| - | data from any Logical Channel, except data from |
| | UL-CCCH; |
| - | MAC CE for Recommended bit rate query; |
| - | MAC CE for BSR included for padding. |
| 5.4.3.2 | Multiplexing of MAC Control Elements and MAC SDUs |

The MAC entity shall multiplex MAC CEs and MAC SDUs in a
MAC PDU according to clauses 5.4.3.1 and 6.1.2.

Referring to Table 9, in relation to resource allocation, when the condition of Table 8 is satisfied, a MAC entity may not generate a MAC PDU for a HARQ entity.

In addition, a base station may transmit a configuration for a mappable LCH for each grant to a UE through separate signaling in SL CG type 1 (e.g., via configuredSLGrantType1 Allowed parameter). Meanwhile, the above-described restriction on an SL grant may be limitedly applied only to an SL grant to which the configuration is not given (e.g., DG, CG type 2). That is, like CG type 1, a base station may limit an operation (e.g., HARQ enable or HARQ disable) to be performed for a specific LCH group, by transmitting a mappable LCH configuration to a UE. For example, a base station may allow a UE to transmit only a HARQ enabled LCH based on a CG type 1 grant. On the other hand, in the case of DG or CG without these restrictions, a base station can configure and transmit a MAC PDU by applying a restrictions on a HARQ operation to the grant proposed above by a UE.

According to an embodiment of the present disclosure, a UE/base station may allocate a grant according to whether a UE's HARQ feedback is enabled or disabled, and the UE may properly configure a MAC PDU according to a received grant and perform sidelink communication.

Meanwhile, in NR SL or NR V2X, HARQ feedback may be supported between a transmitting UE and a receiving UE. Furthermore, a transmitting UE may report an SL HARQ feedback received from a receiving UE to a base station. For example, in order to request a base station to allocate an additional (re)transmission resource, a transmitting UE may report an SL HARQ feedback received from a receiving UE to a base station.

For example, SL HARQ feedback report may be supported as shown in Table 9.

TABLE 10

```
For dynamic grant and configured grant:
  - If the gNB provides PUCCH resources for feedback, the UE
reports SL HARQ feedback to the gNB,
  - If the gNB does not provides PUCCH resources for feedback,
the UE does not report SL HARQ feedback to the gNB.
```

Referring to Table 10, for example, when a base station schedules/allocates an SL resource to a transmitting UE through DG or CG, the base station may additionally schedule/allocate a PUCCH resource related to the SL resource to the transmitting UE. Alternatively, for example, when a base station schedules/allocates an SL resource to a transmitting UE through DG or CG, the base station may not schedule/allocate a PUCCH resource related to the SL resource to the transmitting UE. For example, when a base station schedules/allocates a PUCCH resource related to an SL resource to a transmitting UE, the transmitting UE may report an SL HARQ feedback received from a receiving UE to the base station by using the PUCCH resource. For example, when a base station does not schedule/allocate a PUCCH resource related to an SL resource to a transmitting UE, the transmitting UE may not report an SL HARQ feedback received from a receiving UE to the base station. For example, an SL resource may include at least one of a PSSCH resource, a PSCCH resource, and/or a PSFCH resource.

Meanwhile, in NR SL or NR V2X, a transmitting UE may perform Logical Channel Prioritization (LCP) for configuring a MAC PDU. In addition, as shown in Table 10, HARQ enable and/or HARQ disable may be included in an LCP restriction.

TABLE 11
LCP will lake HARQ A/N enabled/disabled into account, e.g. packet
with HARQ enabled will be multiplexed only with packets with HARQ
enabled.
The logical channel with disabling the HARQ feedback cannot be
multiplexed with a logical channel which enabling the HARQ feedback.

Referring to Table 11, HARQ feedback activation or HARQ feedback deactivation may be considered in LCP. For example, when a transmitting UE configures a MAC PDU, the transmitting UE may configure the MAC PDU by multiplexing only packets in which HARQ feedback is activated. For example, when a transmitting UE configures a MAC PDU, the transmitting UE may configure the MAC PDU by multiplexing only packets in which HARQ feedback is deactivated. For example, a transmitting UE may not configure a MAC PDU by multiplexing a packet in which HARQ feedback is deactivated and a packet in which HARQ feedback is activated. For convenience of description, a MAC PDU including only a packet in which HARQ feedback is enabled may be referred to as a HARQ enable MAC PDU, and a MAC PDU including only a packet in which HARQ feedback is disabled may be referred to as a HARQ disable MAC PDU.

As described above, an SL grant may be defined in three states. For example, a base station may transmit three types of SL grants to a transmitting UE. For example, a first type SL grant may be an SL grant for HARQ enable only, a second type SL grant may be an SL grant for HARQ disable only, a third type SL grant may be an SL grant regardless of HARQ. For example, a first type SL grant may be included in DCI that a UE receives from a base station through a PDCCH. For example, based on a first type SL grant, a UE may be allocated a PSCCH resource, a PSSCH resource, and a PSFCH resource from a base station. In various embodiments of the present disclosure, it is assumed that there is an HARQ restriction for each SL grant.

As described above, a transmitting UE may transmit a MAC PDU generated through an LCP to a receiving UE using a resource allocated through a specific SL grant, according to a type of SL grant transmitted by a base station to the transmitting UE. For example, when a transmitting UE receives a first type SL grant from a base station, the transmitting UE may transmit, to a receiving UE, a MAC PDU composed only of data/packets for which HARQ feedback is activated in an LCP by using an SL resource allocated through the first type SL grant.

On the other hand, even when the above-described SL grant HARQ restriction is applied, a base station may not be able to transmit an appropriate type of grant to a transmitting UE. More specifically, for example, a base station transmits a first type SL grant to a transmitting UE, while the transmitting UE configures/generates a MAC PDU only with data/packets in which HARQ feedback is deactivated through an LCP procedure. For example, a base station transmits a second type SL grant to a transmitting UE, while the transmitting UE configures/generates a MAC PDU only with data/packets in which HARQ feedback is activated through an LCP procedure. Due to the above-mentioned mismatch, various problems may occur. For example, when a base station transmits a second type SL grant to a transmitting UE, and the transmitting UE transmits a HARQ enable MAC PDU to a receiving UE, the transmitting UE may not be able to perform SL transmission within an appropriate latency budget.

Hereinafter, a method for a UE to perform resource reselection and an apparatus supporting the same according to various embodiments of the present disclosure will be described. Also, a method for a UE to temporarily suspend transmission of a MAC PDU and an apparatus supporting the same will be described, according to various embodiments of the present disclosure.

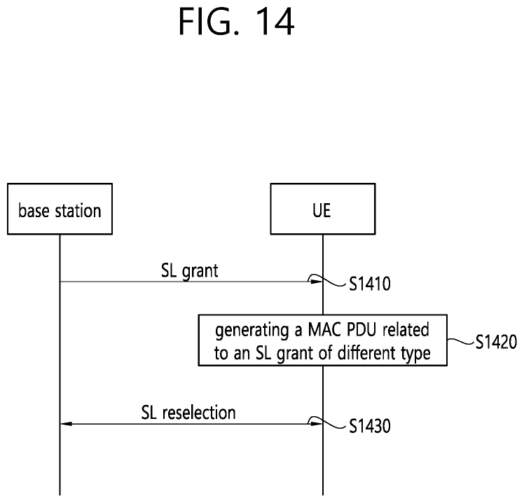

FIG. 14 shows a procedure for a UE to reselect a resource according to an embodiment of the present disclosure. The embodiment of FIG. 14 may be combined with various embodiments of the present disclosure.

Referring to FIG. 14, in step S1410, a UE may receive an SL grant from a base station. For example, a UE may receive DCI including an SL grant through a PDCCH from a base station. For example, a UE may receive an SL grant from a base station through RRC. For example, an SL grant may be a first type SL grant, a second type SL grant, or a third type SL grant. For example, a UE may be allocated a PSCCH resource, a PSSCH resource, and a PSFCH resource from a base station based on a first SL grant. For example, a UE may be allocated a PSCCH resource and a PSSCH resource from a base station based on a second SL grant.

In step S1420, a UE may generate a MAC PDU related to an SL grant of a different type from the received SL grant. For example, although a UE receives a first type SL grant from a base station, the UE may generate a MAC PDU related to a second type SL grant. For example, although a UE receives a second type SL grant from a base station, the UE may generate a MAC PDU related to a first type SL grant. For example, a MAC PDU related to a first type SL grant may include HARQ-enabled data/packet. For example, a MAC PDU related to a second type SL grant may include HARQ-disabled data/packet.

In step S1430, a UE may reselect a resource for transmitting a MAC PDU related to a different type of SL grant. For example, by transmitting at least one of SR and BSR to a base station, a UE may be allocated a resource for transmitting a MAC PDU related to a different type of SL grant from a base station. For example, a UE may reselect a resource for transmitting a MAC PDU related to a different type of SL grant based on a sensing operation.

According to an embodiment of the present disclosure, when a transmitting UE continuously receives a second type SL grant from a base station, and the transmitting UE needs to transmit a HARQ enable MAC PDU to a receiving UE, the transmitting UE may trigger a resource (re)selection. For example, when a transmitting UE receives a first type SL grant from a base station, and the transmitting UE needs to transmit a HARQ disable MAC PDU to a receiving UE, the transmitting UE may trigger a resource (re)selection. For example, when a transmitting UE receives a first type SL grant from a base station, and the transmitting UE needs to transmit a HARQ disable MAC PDU to a receiving UE, the transmitting UE may transmit the HARQ disable MAC PDU to the receiving UE using an SL resource allocated through the first type SL grant. In various embodiments of the present disclosure, an operation of a transmitting UE triggering resource (re)selection may include an operation of a mode 1 transmitting UE transmitting a new SR and/or BSR to a base station when a valid grant does not exist. In various embodiments of the present disclosure, an operation of a transmitting UE triggering resource (re)selection may include an operation of a mode 2 transmitting UE reserving a resource related to SL transmission based on a new sensing operation. In the above case, a transmitting UE may unconditionally trigger resource (re)selection. Alternatively, in the above case, if a transmitting UE does not transmit a MAC PDU to a receiving UE on this transmission occasion, only when it is determined that a Packet Delay Budget (PDB) is not satisfied, the transmitting UE may trigger resource (re)selection.

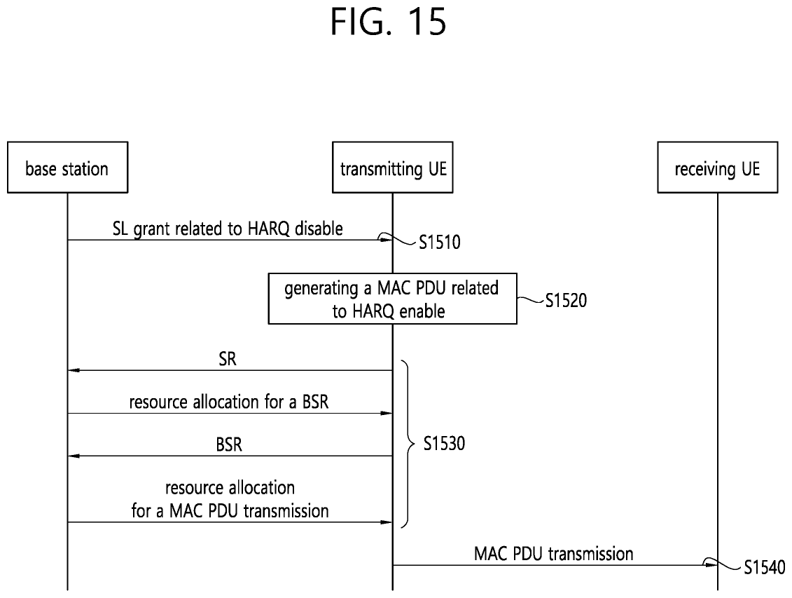

FIG. 15 shows a procedure for a transmitting UE to reselect a resource for transmitting a MAC PDU based on SR/BSR according to an embodiment of the present disclosure. The embodiment of FIG. 15 may be combined with various embodiments of the present disclosure.

Referring to FIG. 15, in step S1510, a transmitting UE may receive an SL grant related to HARQ disabling from a base station. For example, a transmitting UE may receive DCI including a second type SL grant through a PDCCH from a base station. For example, a transmitting UE may receive a second type SL grant from a base station through RRC. For example, a transmitting UE may be allocated a first SL resource based on a second type SL grant from a base station. For example, a first SL resource may include a PSCCH resource and a PSSCH resource, but may not include a PSFCH resource.

In step S1520, a transmitting UE may generate a MAC PDU related to HARQ enable. For example, a transmitting UE may generate a MAC PDU related to a first type SL grant. For example, although a transmitting UE receives a second type SL grant from a base station, the UE may generate a MAC PDU related to a first type SL grant. For example, a MAC PDU related to a first type SL grant may include HARQ-enabled data/packet.

In step S1530, a transmitting UE may be allocated a resource for transmitting a MAC PDU based on an SR/BSR. For example, a transmitting UE may transmit an SR to a base station in order to be allocated a resource for transmitting a MAC PDU related to HARQ enable. A base station allocates resources for a BSR to a transmitting UE based on a received SR, the UE may transmit a BSR to the base station based on the resource for the BSR. A base station may allocate a resource for transmitting a MAC PDU related to HARQ enable to a UE based on a received BSR. For example, a resource for transmitting a MAC PDU related to HARQ enable may be a second SL resource. For example, a second SL resource may include a PSCCH resource, a PSSCH resource, and a PSFCH resource.

In step S1540, a transmitting UE may transmit a MAC PDU to a receiving UE. For example, a transmitting UE may transmit a MAC PDU related to HARQ enable to a receiving UE based on a second SL resource.

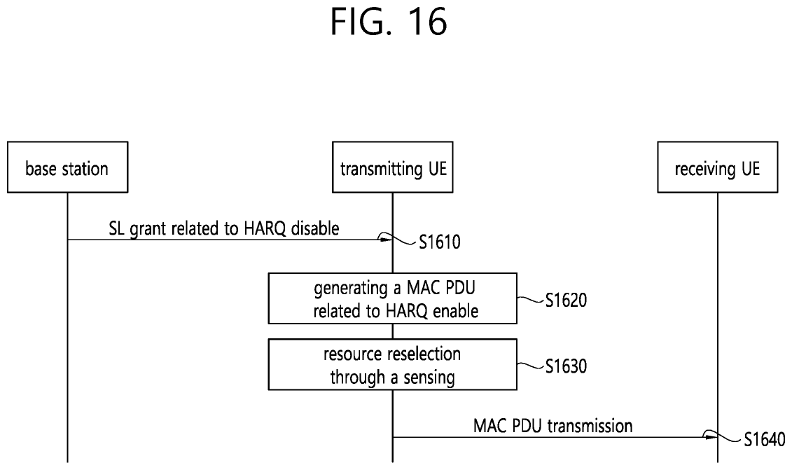

FIG. 16 shows a procedure for a transmitting UE to reselect a resource for transmitting a MAC PDU based on sensing according to an embodiment of the present disclosure. The embodiment of FIG. 16 may be combined with various embodiments of the present disclosure.

Referring to FIG. 16, in step S1610, a transmitting UE may receive an SL grant related to HARQ disable from a base station. For example, a transmitting UE may receive DCI including a second type SL grant through a PDCCH from a base station. For example, a transmitting UE may receive a second type SL grant from a base station through RRC. For example, a transmitting UE may be allocated a first SL resource based on a second type SL grant from a base station. For example, a first SL resource may include a PSCCH resource and a PSSCH resource, but may not include a PSFCH resource.

In step S1620, a transmitting UE may generate a MAC PDU related to HARQ enable. For example, a transmitting UE may generate a MAC PDU related to a first type SL grant. For example, although a UE receives a second type SL grant from a base station, the UE may generate a MAC PDU related to a first type SL grant. For example, a MAC PDU related to a first type SL grant may include HARQ-enabled data/packet.

In step S1630, a transmitting UE may reselect a resource for transmitting a MAC PDU related to HARQ enable through sensing. For example, a mode 1 transmission UE switches the mode to mode 2, and the transmission UE switched to mode 2 may reselect a resource for transmitting a MAC PDU related to HARQ enable based on new sensing operation. For example, a resource for transmitting a MAC PDU related to HARQ enable may be a second SL resource. For example, a second SL resource may include a PSCCH resource, a PSSCH resource, and a PSFCH resource.

In step S1640, a transmitting UE may transmit a MAC PDU to a receiving UE based on a reselected resource. For example, a transmitting UE may transmit a MAC PDU related to HARQ enable to a receiving UE based on a second SL resource.

According to an embodiment of the present disclosure, when a transmitting UE receives a second type SL grant from a base station, and the transmitting UE needs to transmit a HARQ enable MAC PDU to a receiving UE, the transmitting UE may temporarily suspend transmission of the MAC PDU. For example, when a transmitting UE receives a first type SL grant from a base station, and the transmitting UE needs to transmit an HARQ disable MAC PDU to a receiving UE, the transmitting UE may temporarily suspend transmission of the MAC PDU. For example, when a transmitting UE receives a first type SL grant from a base station, and the transmitting UE needs to transmit an HARQ disable MAC PDU to a receiving UE, the transmitting UE may transmit the HARQ disable MAC PDU to the receiving UE using an SL resource allocated through the first type SL grant.

For example, when a transmitting UE temporarily suspends transmission of a HARQ enable MAC PDU, the transmitting UE may receive a first type SL grant and/or a third type SL grant from a base station thereafter. And, for example, a transmitting UE may transmit a MAC PDU to a receiving UE by using an SL resource allocated through a first type SL grant and/or a third type SL grant. For example, a transmitting UE may release the suspension of MAC PDU transmission based on a first type SL grant and/or a third type SL grant.

For example, when a transmitting UE temporarily suspends transmission of a HARQ disable MAC PDU, the transmitting UE may receive a second type SL grant and/or a third type SL grant from a base station thereafter. And, for example, a transmitting UE may transmit a MAC PDU to a receiving UE using an SL resource allocated through a second type SL grant and/or a third type SL grant. For example, a transmitting UE may release the suspension of MAC PDU transmission based on a first type SL grant and/or a third type SL grant.

For example, a transmitting UE may not receive a grant of a type suitable for HARQ operation from a base station even afterward. Or, for example, due to the suspension of MAC PDU transmission, a transmitting UE may determine that a PDB (Packet Delay Budget) is exceeded. In this case, for example, a transmitting UE may trigger a resource (re)selection. Or, for example, a transmitting UE may not transmit a MAC PDU. For example, a transmitting UE may drop a MAC PDU.

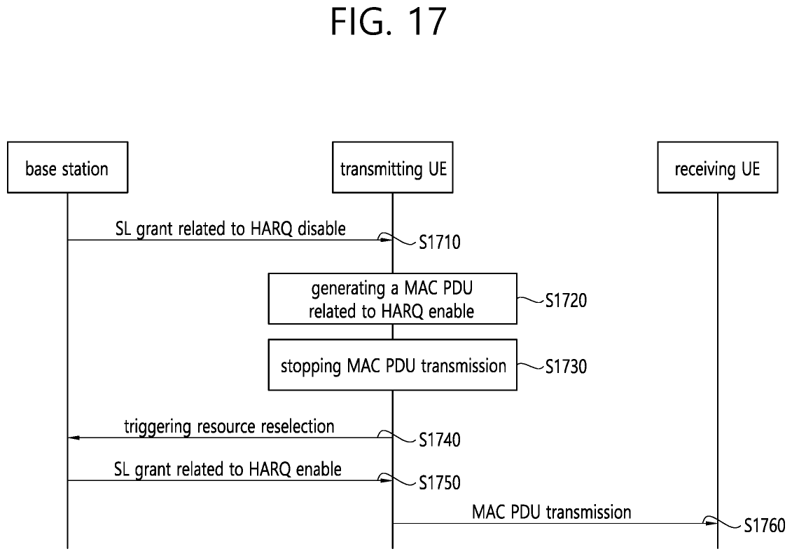

FIG. 17 shows a procedure for reselecting a resource by a transmitting UE according to an embodiment of the present disclosure. The embodiment of FIG. 17 may be combined with various embodiments of the present disclosure.

Referring to FIG. 17, in step S1710, a transmitting UE may receive an SL grant related to HARQ disable from a base station. For example, a transmitting UE may receive the DCI including a second type SL grant through a PDCCH from a base station. For example, a transmitting UE may receive a second type SL grant from a base station through RRC. For example, a transmitting UE may be allocated a first SL resource based on a second type SL grant from a base station. For example, a first SL resource may include a PSCCH resource and a PSSCH resource, but may not include a PSFCH resource.

In step S1720, a transmitting UE may generate a MAC PDU related to HARQ enable. For example, a transmitting UE may generate a MAC PDU related to a first type SL grant. For example, although a transmitting UE receives a second type SL grant from a base station, the UE may generate a MAC PDU related to a first type SL grant. For example, a MAC PDU related to a first type SL grant may include HARQ-enabled data/packet.

In step S1730, a transmitting UE may stop transmitting a MAC PDU. For example, a transmitting UE may temporarily stop transmitting a MAC PDU. For example, a transmitting UE may determine that a PDB is exceeded because a transmission of a MAC PDU related to HARQ enable is stopped. In this case, for example, a transmitting UE may trigger resource reselection. Or, for example, a transmitting UE may omit transmission of a MAC PDU related to HARQ enable.

In step S1740, a transmitting UE may trigger a resource reselection to a base station. For example, a transmitting UE may trigger resource reselection to a base station based on a determination that a Packet Delay Budget (PDB) is exceeded due to the suspension of MAC PDU transmission. For example, a transmitting UE may request a resource for transmitting a MAC PDU related to HARQ enable from a base station. For example, a transmitting UE may transmit at least one of SR and BSR to a base station. For example, a resource for transmitting a MAC PDU related to HARQ enable may be a second SL resource.

In step S1750, a transmitting UE may receive an SL grant related to HARQ enable from a base station. For example, a base station may transmit an SL grant related to HARQ enable to a transmitting UE based on a resource request related to HARQ enable. For example, a base station may transmit a first type SL grant to a transmitting UE, based on receiving a second SL resource request from the transmitting UE. For example, a base station may transmit DCI including a first type SL grant to a transmitting UE through a PDCCH, based on receiving a second SL resource request from the transmitting UE. For example, a base station may transmit a first type SL grant to a transmitting UE through RRC, based on receiving a second SL resource request from the transmitting UE. For example, a transmitting UE may cancel a transmission of a MAC PDU based on a received first type SL grant.

In step S1760, a transmitting UE may transmit a MAC PDU to a receiving UE. For example, a transmitting UE may transmit a MAC PDU to a receiving UE based on a resource related to HARQ enable allocated from a base station. For example, a transmitting UE may transmit a MAC PDU to a receiving UE based on a second SL resource. For example, a transmitting UE may release the suspension of MAC PDU transmission of a HARQ enable MAC PDU based on a received first type SL grant, and the transmitting UE may transmit a HARQ enable MAC PDU to a receiving UE through a second SL resource allocated by the first type SL grant.

For example, a mode 1 transmitting UE may receive a second type SL grant from a base station, and the mode 1 transmitting UE may have to transmit an HARQ enable MAC PDU to a receiving UE. For example, a mode 1 transmitting UE may receive a first type SL grant from a base station, and the mode 1 transmitting UE may have to transmit a HARQ disable MAC PDU to a receiving UE. In the above case, assuming that a mode 1 transmission UE is a simultaneous mode UE, the mode 1 transmission UE may switch to mode 2. After then, for example, the mode 2 transmitting UE may perform resource (re)selection, and may perform SL communication with a receiving UE using a selected mode 2 resource. In addition, as described above, when a mode 1 transmitting UE does not receive an appropriate grant from a base station, and the mode 1 transmitting UE determines that PDB is not satisfied, the mode 1 transmitting UE may switch to mode 2 and perform SL communication with a receiving UE.

Various embodiments of the present disclosure may be combined with a synchronization operation of a UE and/or an SL HARQ feedback operation of a UE.

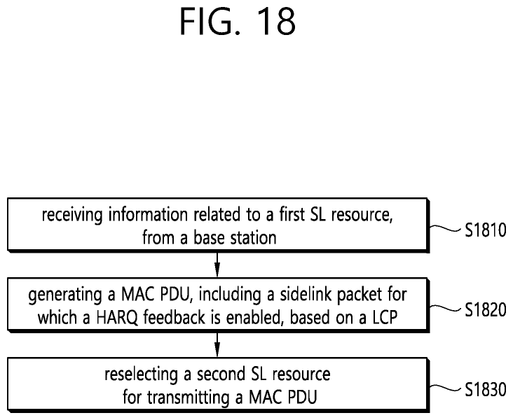

FIG. 18 shows a method for a first apparatus to reselect a resource for transmitting a MAC PDU according to an embodiment of the present disclosure. The embodiment of FIG. 18 may be combined with various embodiments of the present disclosure.

Referring to FIG. 18, in step S1810, a first apparatus 100 may receive information related to a first sidelink (SL) resource, from a base station. For example, the first SL resource may include a physical sidelink control channel (PSCCH) resource and a physical sidelink shared channel (PSSCH) resource, and the first SL resource may not include a physical sidelink feedback channel (PSFCH) resource.

In step S1820, a first apparatus 100 may generate a medium access control protocol data unit (MAC PDU), including a sidelink packet for which a hybrid automatic repeat request (HARQ) feedback is enabled, based on a logical channel priority (LCP). For example, the MAC PDU may not include a sidelink packet for which a HARQ feedback is disabled

In step S1830, a first apparatus 100 may reselect a second SL resource for transmitting the MAC PDU. For example, a first apparatus 100 may transmit at least one of a scheduling request (SR) or a buffer state report (BSR) to the base station. And, a first apparatus 100 may receive information related to the second SL resource from the base station, based on at least one of the SR or the BSR, and a first apparatus 100 may reselect the second SL resource. For example, the second SL resource may include a PSCCH resource, a PSSCH resource and a PSFCH resource. For example, a first apparatus 100 may reselect the second SL resource for transmitting the MAC PDU through a sensing operation of the first apparatus 100. For example, a first apparatus 100 may reselect the second SL resource based on a determination that the time point for transmitting the MAC PDU exceeds a packet delay budget (PDB). For example, a first apparatus 100 may transmit the MAC PDU to the second apparatus 200 based on the reselected second SL resource.

For example, the transmission of the MAC PDU may be temporarily stopped before reselecting the second SL resource. For example, a first apparatus 100 may temporarily stop the transmission of the MAC PDU before reselecting the second SL resource. For example, a first apparatus 100 may receive information related to the second SL resource, from the base station, and a first apparatus 100 may release the stopped transmission of the MAC PDU based on the information related to the second SL resource. For example, a first apparatus 100 may transmit the MAC PDU to a second apparatus through the reselected second SL resource. For example, the transmission to the second apparatus may be omitted, based on a determination that the time point for transmitting the MAC PDU exceeds the PDB while the transmission of the MAC PDU is stopped. For example, a first apparatus 100 may omit the transmission to the second apparatus, based on a determination that the time point for transmitting the MAC PDU exceeds the PDB while the transmission of the MAC PDU is stopped.

For example, whether the HARQ feedback is enabled or disabled may be configured by the base station per sidelink radio bearer (SLRB) level. For example, whether the HARQ feedback is enabled or disabled may be configured by the base station based on at least one of a QoS requirement or CBR reported from the first apparatus 100. For example, whether the HARQ feedback is enabled or disabled may be indicated based on an index included in the information related to the first SL resource. For example, whether the HARQ feedback is enabled or disabled may be indicated based on an index of an SLRB or a logical channel (LCH) mapped to the information related to the first SL resource.

The above-described embodiment may be applied to various apparatuses to be described below. For example, a processor 102 of a first apparatus 100 may control a transceiver 106 to receive information related to a first sidelink (SL) resource, from a base station. And, a processor 102 of a first apparatus 100 may generate a medium access control protocol data unit (MAC PDU), including a sidelink packet for which a hybrid automatic repeat request (HARQ) feedback is enabled, based on a logical channel priority (LCP). And, a processor 102 of a first apparatus 100 may reselect a second SL resource for transmitting the MAC PDU.

According to an embodiment of the present disclosure, a first apparatus for performing wireless communication may be proposed. For example, the first apparatus may comprise: one or more memories storing instructions; one or more transceivers; and one or more processors connected to the one or more memories and the one or more transceivers. For example, the one or more processors may execute the instructions to: receive information related to a first sidelink (SL) resource, from a base station, wherein the first SL resource includes a physical sidelink control channel (PSCCH) resource and a physical sidelink shared channel (PSSCH) resource, and wherein the first SL resource doesn't include a physical sidelink feedback channel (PSFCH) resource; generate a medium access control protocol data unit (MAC PDU), including a sidelink packet for which a hybrid automatic repeat request (HARQ) feedback is enabled, based on a logical channel priority (LCP), wherein the MAC PDU doesn't include a sidelink packet for which a HARQ feedback is disabled; and reselect a second SL resource for transmitting the MAC PDU.

According to an embodiment of the present disclosure, an apparatus configured to control a first user equipment (UE) may be proposed. For example, the apparatus may comprise: one or more processors; and one or more memories operably connectable to the one or more processors and storing instructions, wherein the one or more processors execute the instructions to: receive information related to a first sidelink (SL) resource, from a base station, wherein the first SL resource includes a physical sidelink control channel (PSCCH) resource and a physical sidelink shared channel (PSSCH) resource, and wherein the first SL resource doesn't include a physical sidelink feedback channel (PSFCH) resource; generate a medium access control protocol data unit (MAC PDU), including a sidelink packet for which a hybrid automatic repeat request (HARQ) feedback is enabled, based on a logical channel priority (LCP), wherein the MAC PDU doesn't include a sidelink packet for which a HARQ feedback is disabled; and reselect a second SL resource for transmitting the MAC PDU.

According to an embodiment of the present disclosure, a non-transitory computer-readable storage medium storing instructions may be proposed. For example, the instructions, when executed, may cause a first apparatus to: receive information related to a first sidelink (SL) resource, from a base station, wherein the first SL resource includes a physical sidelink control channel (PSCCH) resource and a physical sidelink shared channel (PSSCH) resource, and wherein the first SL resource doesn't include a physical sidelink feedback channel (PSFCH) resource; generate a medium access control protocol data unit (MAC PDU), including a sidelink packet for which a hybrid automatic repeat request (HARQ) feedback is enabled, based on a logical channel priority (LCP), wherein the MAC PDU doesn't include a sidelink packet for which a HARQ feedback is disabled; and reselect a second SL resource for transmitting the MAC PDU.

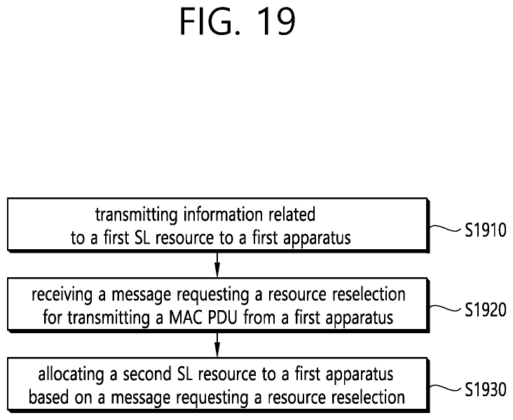

FIG. 19 shows a method for a base station to allocate resources to a first apparatus according to an embodiment of the present disclosure. The embodiment of FIG. 19 may be combined with various embodiments of the present disclosure.

Referring to FIG. 19, in step S1910, a base station may transmit information related to a first sidelink (SL) resource to a first apparatus 100. For example, the first SL resource may include a physical sidelink control channel (PSCCH) resource and a physical sidelink shared channel (PSSCH) resource, and may not include a physical sidelink feedback channel (PSFCH) resource.

In step S1920, a base station may receive a message requesting a resource reselection for transmitting a medium access control protocol data unit (MAC PDU) from the first apparatus 100. For example, the MAC PDU may be generated based on a logical channel priority (LCP) by the first apparatus 100. For example, the MAC PDU may include a sidelink packet for which a hybrid automatic repeat request (HARQ) feedback is enabled, and may not include a sidelink packet for which a HARQ feedback is disabled. For example, the message requesting the resource reselection may include at least one of a scheduling request (SR) or a buffer state report (BSR).

In step S1930, a base station may allocate a second SL resource to the first apparatus 100 based on the message requesting the resource reselection. For example, the second SL resource may include a PSCCH resource, a PSSCH resource and a PSFCH resource.

For example, the transmission of the MAC PDU may be temporarily stopped before reselecting the second SL resource. For example, a base station may transmit information related to the second SL resource to the first apparatus 100, and a first apparatus 100 may release the stopped transmission of the MAC PDU based on the information related to the second SL resource. For example, the transmission to the second apparatus may be omitted, based on a determination that the time point for transmitting the MAC PDU exceeds the PDB while the transmission of the MAC PDU is stopped.

For example, a base station may configure whether the HARQ feedback is enabled or disabled per sidelink radio bearer (SLRB) level. For example, whether the HARQ feedback is enabled or disabled may be configured by the base station based on at least one of a QoS requirement or CBR reported from the first apparatus 100. For example, whether the HARQ feedback is enabled or disabled may be indicated based on an index included in the information related to the first SL resource. For example, whether the HARQ feedback is enabled or disabled may be indicated based on an index of an SLRB or a logical channel (LCH) mapped to the information related to the first SL resource.

The above-described embodiment may be applied to various apparatuses to be described below.

According to an embodiment of the present disclosure, a base station for performing wireless communication may be proposed. For example, the base station may comprise: one or more memories storing instructions; one or more transceivers; and one or more processors connected to the one or more memories and the one or more transceivers. For example, the one or more processors may execute the instructions to: transmit information related to a first sidelink (SL) resource to a first apparatus; receive a message requesting a resource reselection for transmitting a medium access control protocol data unit (MAC PDU) from the first apparatus; and allocate a second SL resource to the first apparatus based on the message requesting the resource reselection, wherein the MAC PDU is generated based on a logical channel priority (LCP) by the first apparatus, wherein the first SL resource includes a physical sidelink control channel (PSCCH) resource and a physical sidelink shared channel (PSSCH) resource, wherein the first SL resource doesn't include a physical sidelink feedback channel (PSFCH) resource; wherein the MAC PDU includes a sidelink packet for which a hybrid automatic repeat request (HARQ) feedback is enabled, and wherein the MAC PDU doesn't include a sidelink packet for which a HARQ feedback is disabled.

Hereinafter, an apparatus to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

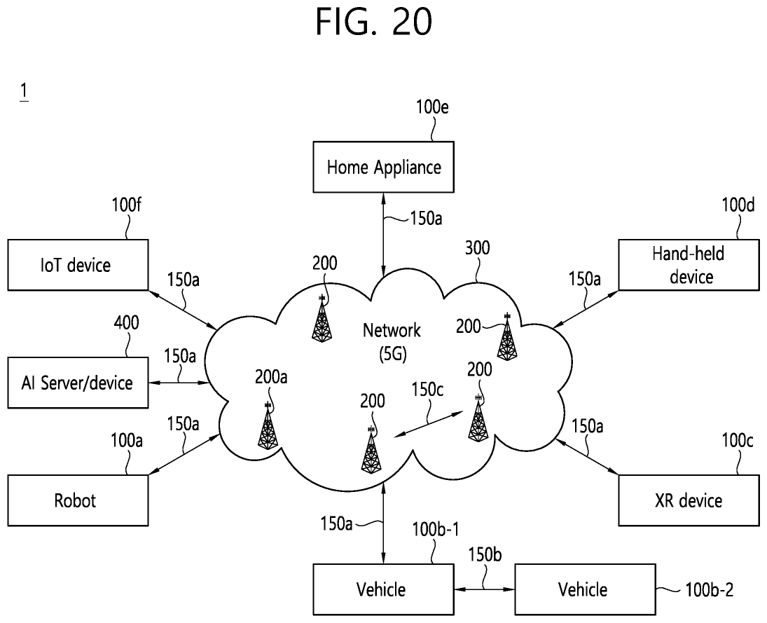

FIG. 20 shows a communication system 1, in accordance with an embodiment of the present disclosure.

Referring to FIG. 20, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

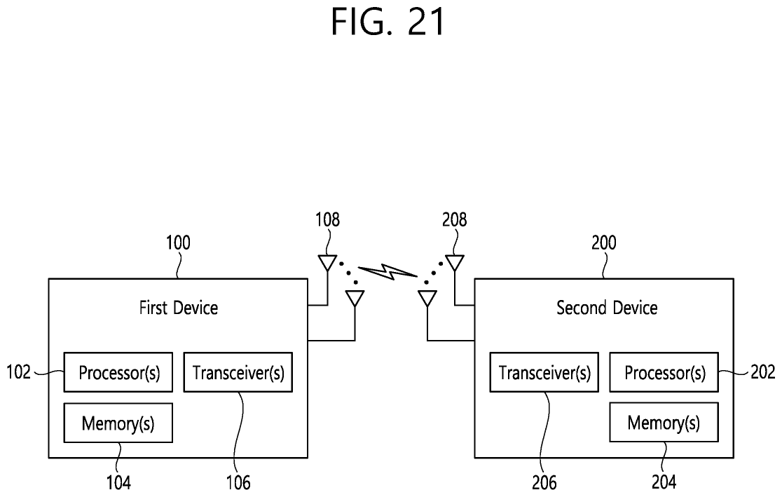

FIG. 21 shows wireless devices, in accordance with an embodiment of the present disclosure.

Referring to FIG. 21, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 20.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

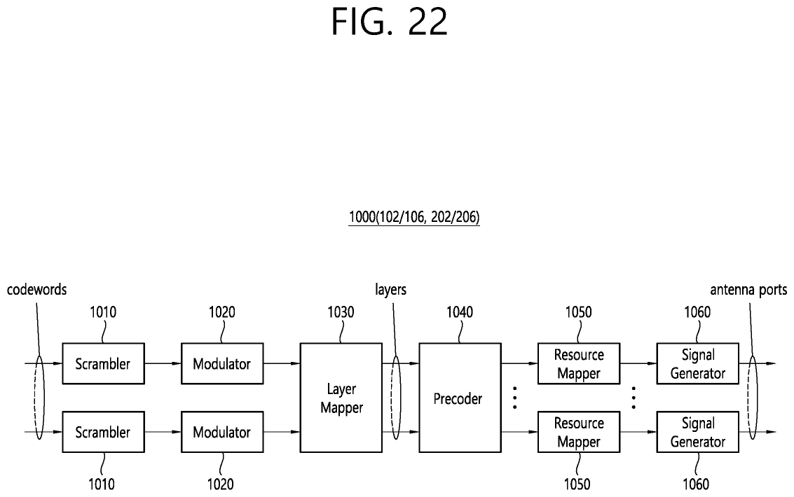

FIG. 22 shows a signal process circuit for a transmission signal, in accordance with an embodiment of the present disclosure.

Referring to FIG. 22, a signal processing circuit 1000 may include scramblers 1010, modulators 1020, a layer mapper 1030, a precoder 1040, resource mappers 1050, and signal generators 1060. An operation/function of FIG. 22 may be performed, without being limited to, the processors 102 and 202 and/or the transceivers 106 and 206 of FIG. 21. Hardware elements of FIG. 22 may be implemented by the processors 102 and 202 and/or the transceivers 106 and 206 of FIG. 21. For example, blocks 1010 to 1060 may be implemented by the processors 102 and 202 of FIG. 21. Alternatively, the blocks 1010 to 1050 may be implemented by the processors 102 and 202 of FIG. 21 and the block 1060 may be implemented by the transceivers 106 and 206 of FIG. 21.

Codewords may be converted into radio signals via the signal processing circuit 1000 of FIG. 22. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 22. For example, the wireless devices (e.g., 100 and 200 of FIG. 21) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

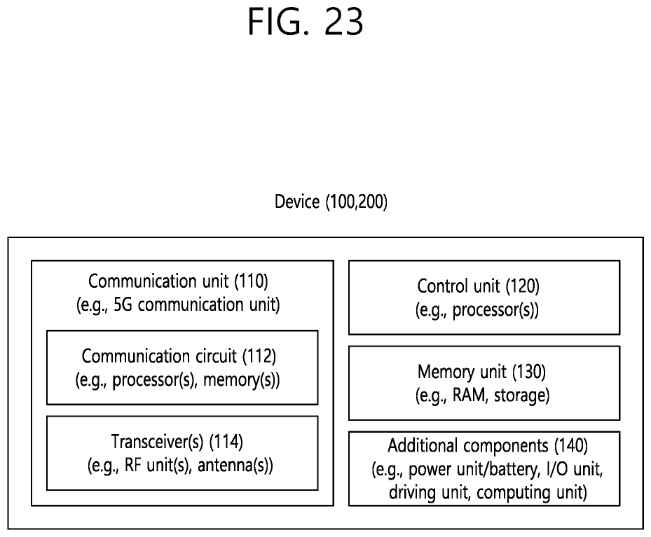

FIG. 23 shows another example of a wireless device, in accordance with an embodiment of the present disclosure. The wireless device may be implemented in various forms according to a use-case/service (refer to FIG. 20).

Referring to FIG. 23, wireless devices 100 and 200 may correspond to the wireless devices 100 and 200 of FIG. 21 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 21. For example, the transceiver(s) 114 may include the one or more transceivers 106 and 206 and/or the one or more antennas 108 and 208 of FIG. 21. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 20), the vehicles (100b-1 and 100b-2 of FIG. 20), the XR device (100c of FIG. 20), the hand-held device (100d of FIG. 20), the home appliance (100e of FIG. 20), the IoT device (100f of FIG. 20), a digital broadcast terminal, a hologram device, a public safety device, an MTC device, a medicine device, a fintech device (or a finance device), a security device, a climate/environment device, the AI server/device (400 of FIG. 20), the BSs (200 of FIG. 20), a network node, etc. The wireless device may be used in a mobile or fixed place according to a use-example/service.

In FIG. 23, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 23 will be described in detail with reference to the drawings.

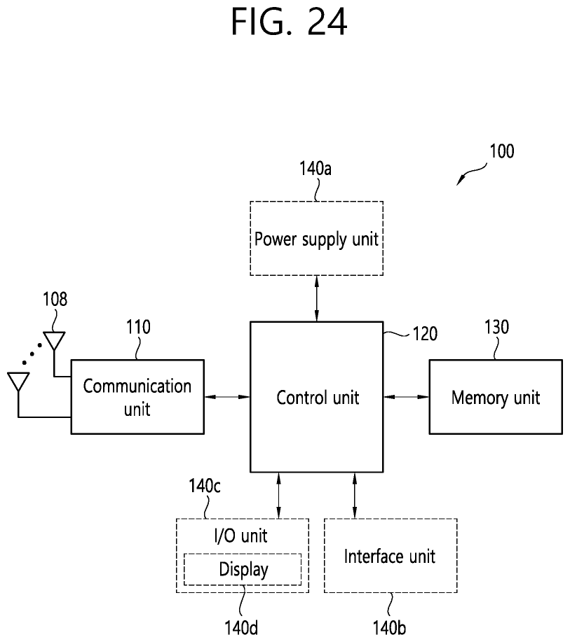

FIG. 24 shows a hand-held device, in accordance with an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 24, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 23, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

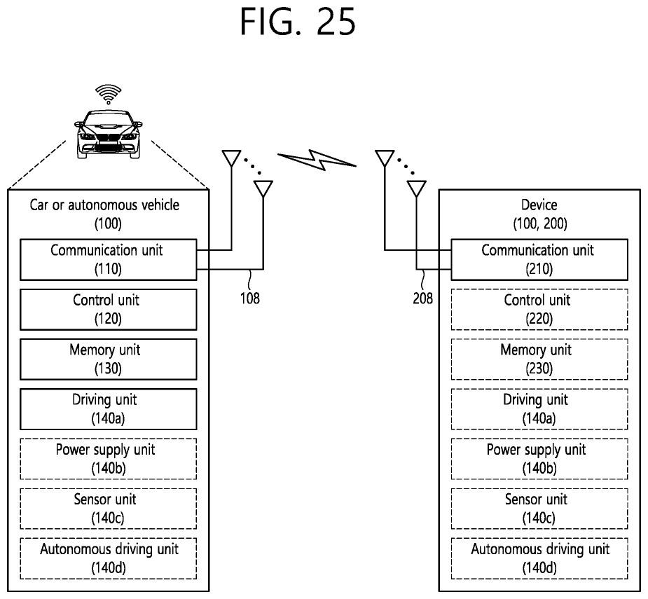

FIG. 25 shows a vehicle or an autonomous vehicle, in accordance with an embodiment of the present disclosure. The vehicle or autonomous vehicle may be implemented by a mobile robot, a car, a train, a manned/unmanned Aerial Vehicle (AV), a ship, etc.

Referring to FIG. 25, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 23, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1. A method for performing, by a first apparatus, wireless communication, the method comprising:
receiving information related to a first sidelink (SL) resource, from a base station,
wherein the first SL resource includes a physical sidelink control channel (PSCCH) resource and a physical sidelink shared channel (PSSCH) resource, and
wherein the first SL resource doesn't include a physical sidelink feedback channel (PSFCH) resource;
generating a medium access control protocol data unit (MAC PDU), including a sidelink packet for which a hybrid automatic repeat request (HARQ) feedback is enabled, based on a logical channel priority (LCP),
wherein the MAC PDU doesn't include a sidelink packet for which a HARQ feedback is disabled; and
reselecting a second SL resource for transmitting the MAC PDU.

2. The method of claim 1, wherein the step of reselecting the second SL resource includes:
transmitting at least one of a scheduling request (SR) or a buffer state report (BSR) to the base station;
receiving information related to the second SL resource from the base station, based on at least one of the SR or the BSR; and
reselecting the second SL resource, and
wherein the second SL resource includes a PSCCH resource, a PSSCH resource and a PSFCH resource.

3. The method of claim 1, wherein the step of reselecting the second SL resource includes:
reselecting the second SL resource for transmitting the MAC PDU through a sensing operation of the first apparatus.

4. The method of claim 1, wherein the step of reselecting the second SL resource is performed based on a determination that the time point for transmitting the MAC PDU exceeds a packet delay budget (PDB).

5. The method of claim 1, wherein the transmission of the MAC PDU is temporarily stopped before reselecting the second SL resource.

6. The method of claim 5, further comprising:
receiving information related to the second SL resource, from the base station,
wherein the second SL resource includes a PSCCH resource, PSSCH resource and a PSFCH resource; and
releasing the stopped transmission of the MAC PDU based on the information related to the second SL resource.

7. The method of claim 6, further comprising:
transmitting the MAC PDU to a second apparatus through the reselected second SL resource.

8. The method of claim 5, wherein the transmission to the second apparatus is omitted, based on a determination that the time point for transmitting the MAC PDU exceeds the PDB while the transmission of the MAC PDU is stopped.

9. The method of claim 1, further comprising:
transmitting the MAC PDU to the second apparatus based on the reselected second SL resource.

10. The method of claim 1, wherein whether the HARQ feedback is enabled or disabled is configured by the base station per sidelink radio bearer (SLRB) level.

11. The method of claim 1, wherein whether the HARQ feedback is enabled or disabled is configured by the base station based on at least one of a QoS requirement or CBR reported from the first apparatus.

12. The method of claim 1, wherein whether the HARQ feedback is enabled or disabled is indicated based on an index included in the information related to the first SL resource.

13. The method of claim 1, wherein whether the HARQ feedback is enabled or disabled is indicated based on an index of an SLRB or a logical channel (LCH) mapped to the information related to the first SL resource.

14. A first apparatus for performing wireless communication, the first apparatus comprising:
one or more memories storing instructions;
one or more transceivers; and
one or more processors connected to the one or more memories and the one or more transceivers, wherein the one or more processors execute the instructions to:
receive information related to a first sidelink (SL) resource, from a base station,
wherein the first SL resource includes a physical sidelink control channel (PSCCH) resource and a physical sidelink shared channel (PSSCH) resource, and
wherein the first SL resource doesn't include a physical sidelink feedback channel (PSFCH) resource;
generate a medium access control protocol data unit (MAC PDU), including a sidelink packet for which a hybrid automatic repeat request (HARQ) feedback is enabled, based on a logical channel priority (LCP),
wherein the MAC PDU doesn't include a sidelink packet for which a HARQ feedback is disabled; and
reselect a second SL resource for transmitting the MAC PDU.

15. An apparatus configured to control a first user equipment (UE), the apparatus comprising:
one or more processors; and
one or more memories operably connectable to the one or more processors and storing instructions, wherein the one or more processors execute the instructions to:
receive information related to a first sidelink (SL) resource, from a base station,
wherein the first SL resource includes a physical sidelink control channel (PSCCH) resource and a physical sidelink shared channel (PSSCH) resource, and
wherein the first SL resource doesn't include a physical sidelink feedback channel (PSFCH) resource;
generate a medium access control protocol data unit (MAC PDU), including a sidelink packet for which a hybrid automatic repeat request (HARQ) feedback is enabled, based on a logical channel priority (LCP),
wherein the MAC PDU doesn't include a sidelink packet for which a HARQ feedback is disabled; and
reselect a second SL resource for transmitting the MAC PDU.

16-20. (canceled)
